(19) United States
(12) Patent Application Publication
(10) Pub. No.: US 2025/0234245 A1
(43) Pub. Date: Jul. 17, 2025

(54) METHOD AND APPARATUS FOR HANDLING PDCP DUPLICATION

(71) Applicant: Telefonaktiebolaget LM Ericsson (publ), Stockholm (SE)

(72) Inventors: Min WANG, Luleå (SE); Zhang ZHANG, Beijing (CN)

(73) Assignee: Telefonaktiebolaget LM Ericsson (publ), Stockholm (SE)

(21) Appl. No.: 18/853,701

(22) PCT Filed: Mar. 10, 2023
(86) PCT No.: PCT/CN2023/080723

§ 371 Date: Oct. 2, 2024

(30) Foreign Application Priority Data
Apr. 4, 2022 (WO) PCT/CN2022/085213

(51) Int. Cl. H04W 28/06; H04L 5/00; H04W 76/19; H04W 92/18

(52) U.S. Cl. CPC H04W 28/06; H04L 5/0053; H04W 76/19; H04W 92/18

(57) ABSTRACT

Embodiments of the present disclosure provide method and apparatus for handling PDCP duplication. A method performed by a first UE comprises. for an uplink radio bearer that has been activated with PDCP duplication, determining that a PDCP PDU has been successfully delivered to a network node via a relay UE on a UE-to-network relay path. The method may further comprise discarding at least one duplicated PDCP PDU on at least one other UE-to-network path.

### TECHNICAL FIELD

The non-limiting and exemplary embodiments of the present disclosure generally relate to the technical field of communications, and specifically to methods and apparatuses for handling packet data convergence protocol (PDCP) duplication.

### BACKGROUND

This section introduces aspects that may facilitate a better understanding of the disclosure. Accordingly, the statements of this section are to be read in this light and are not to be understood as admissions about what is in the prior art or what is not in the prior art.

In communication networks for example LTE (Long Term Evolution) and NR (new radio) as defined by 3rd Generation Partnership Project (3GPP), there may be various relay scenarios such as layer-2 based UE (user equipment) to network (NW) relay.

Moreover packet duplication may be used in communication networks such as LTE and NR. When duplication is configured for a radio bearer, at least one secondary entity is added to the radio bearer to handle the duplicated packet, where a logical channel corresponding to a primary entity is referred to as the primary logical channel, and a logical channel corresponding to a secondary entity is referred to the secondary logical channel.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Sidelink (SL) relay is being standardized in 3GPP NR Release 17 (Rel-17), which enables a remote UE to be able to connect to a network node (such as a base station) via a relay UE. During the 3GPP NR Release 17 time phase, the remote UE may be in coverage (IC) or out of coverage (OOC). For the remote UE which is in IC and has both direct connection and indirect connection, the remote UE only allows to use a single connectivity to transmit data. Due to this restriction, it would be reasonable and straightforward for the remote UE to only use the indirection connection to transmit data to the network node. With this restriction i.e., the remote UE only uses single connectivity for data transfer and reception, it is beneficial to simplify design efforts in 3GPP NR Release 17. However, the drawback is that the remote UE is not able to utilize the second connection although it is available. In case of high data volume, it would be very helpful if the remote UE in IC can utilize both a direct connection and an indirect connection to achieve aggregated data rate over both connections.

In a draft of NR sidelink relay enhancements (i.e., 3GPP TSG RAN Meeting #94e, RP-213585, Electronic Meeting, Dec. 6-17, 2021), the following study objective has been defined to be studied in 3GPP Release 18 time frame.

3. Study the benefit and potential solutions for multi-path support to enhance reliability and throughput (e.g., by switching among or utilizing the multiple paths simultaneously) in the following scenarios [RAN2, RAN3]:

A. A UE is connected to the same gNB using one direct path and one indirect path via 1) Layer-2 UE-to-Network relay.

As highlighted in the above objective, a UE is allowed to connect to the same gNB using both a direct path and an indirect path via a L2 (Layer-2) UE-to-Network relay UE.

Since one of the intentions of supporting multi-path is to enhance reliability, it would be straightforward to support packet duplication in this case.

An important function for packet duplication is to remove duplicate protocol data unit (PDU) at packet data convergence protocol (PDCP) layer in cases including:
1) if the successful delivery of a PDCP Data PDU is confirmed by one of the associated AM (Acknowledged Mode) RLC (Radio Link Control) entities,
2) if the deactivation of PDCP duplication is indicated for the data radio bearers (DRB), or
3) if the deactivation of PDCP duplication is indicated for at least one associated RLC entities.

In addition, UE also needs to remove SDUs at RLC layer in case it is indicated by PDCP layer.

For cases where a UE is configured with both a direct path and an indirect path and PDCP duplication is enabled for at least one radio bearer (RB), all the above procedures would need enhancements due to the following observed issues.

Issue 1: the indirect path contains two hops where RLC entities are established for duplication purpose at each hop, therefore, how to determine whether a PDCP PDU has been successfully delivered in this case needs to be studied. It may be insufficient for the UE to make a determination to only rely on RLC status provided by one hop.

Issue 2: in the indirect path, RLC entities and PDCP entities are not collocated. In case the UE receives a signaling from the network node such as gNB indicating deactivation of PDCP duplication for an RB, how UE informs associated RLC entities of the signaling also needs to be studied.

Therefore, it is necessary to study the above issues and develop corresponding solutions.

In a first aspect of the disclosure, there is provided a method performed by a first UE. The method may comprise, for an uplink radio bearer that has been activated with packet data convergence protocol (PDCP) duplication, determining that a PDCP protocol data unit (PDU) has been successfully delivered to a network node via a relay UE on a UE-to-network relay path. The method may further comprise discarding at least one duplicated PDCP PDU on at least one other UE-to-network path.

In an embodiment, the at least one other UE-to-network path may comprise at least one of a UE-to-network relay path, or a UE-to-network direct path.

In an embodiment, determining that the PDCP PDU has been successfully delivered to the network node via the relay UE on the UE-to-network relay path may comprise: receiving a radio link control (RLC) status report from the relay UE and determining that the PDCP PDU has been successfully delivered to the network node via the relay UE on the UE-to-network relay path based on the RLC status report. The RLC status report indicates that the PDCP PDU has been successfully transmitted to the relay UE in a sidelink.

In an embodiment, determining that the PDCP PDU has been successfully delivered to the network node via the relay UE on the UE-to-network relay path may comprise: receiving a PDCP status report from the network node and determining that the PDCP PDU has been successfully delivered to the network node on the UE-to-network relay path based on the PDCP status report., The PDCP status report indicates that the PDCP PDU has been successfully received by the network node via the UE-to-network relay path.

In an embodiment, the PDCP status report may be received from the network node when at least one of an upper layer requests a PDCP entity re-establishment, an upper layer requests a PDCP data recovery, an upper layer requests a uplink data switching, an upper layer reconfigures a PDCP entity to release dual active protocol stack (DAPS) and daps-SourceRelease is configured in upper layer, an upper layer determines that a PDCP status report needs to be triggered, a periodic timer is expired, or PDCP duplication has been activated and at least one path for PDCP duplication is the UE-to-network relay path.

In an embodiment, the upper layer may comprise a radio resource control (RRC) layer.

In an embodiment, the PDCP status report is received from the network node via a UE-to-network direct path and/or the UE-to-network relay path.

In an embodiment, determining that the PDCP PDU has been successfully delivered to the network node via the relay UE on the UE-to-network relay path may comprise: receiving a first signaling from the relay UE and determining that the PDCP PDU has been successfully delivered to the network node via the relay UE on the UE-to-network relay path based on the first signaling. The first signaling indicates that the relay UE has received a RLC status report for the PDCP PDU from the network node. The RLC status report indicates that the PDCP PDU has been successfully transmitted to the network node in a Uu link.

In an embodiment, determining that the PDCP PDU has been successfully delivered to the network node via the relay UE on the UE-to-network relay path may comprise: receiving a second signaling from the network node via a UE-to-network direct path and determining that the PDCP PDU has been successfully delivered to the network node via the relay UE on the UE-to-network relay path based on the second signaling. The second signaling indicates that the PDCP PDU has been successfully received by the network node via the UE-to-network relay path.

In an embodiment, the method may further comprise receiving a third signaling from the network node. The third signaling indicates deactivation of PDCP duplication of the uplink radio bearer. The method may further comprise performing at least one of: deactivating the PDCP duplication for the uplink radio bearer; discarding at least one first duplicated PDCP PDU and/or RLC service data unit (SDU) associated with the uplink radio bearer; or sending a fourth signaling to the relay UE. The fourth signaling indicates the relay UE to discard at least one second duplicated PDCP PDU and/or RLC SDU associated with the uplink radio bearer.

In an embodiment, the at least one second duplicated PDCP PDU and/or RLC SDU may comprise at least one of one or more PDCP PDUs and/or RLC SDUs associated with the uplink radio bearer that are received from the first UE and stored in at least one sidelink RLC entity, or one or more PDCP PDUs and/or RLC SDUs associated with the uplink radio bearer that are stored in at least one Uu RLC entity.

In an embodiment, the method may further comprise receiving a fifth signaling from the network node. The fifth signaling indicates deactivation of PDCP duplication of the uplink radio bearer for at least one sidelink RLC entity. The method may further comprise performing at least one of discarding at least one third duplicated PDCP PDU and/or RLC SDU associated with the uplink radio bearer of the at least one RLC entity; or sending a sixth signaling to the relay UE. The sixth signaling indicates the relay UE to discard at least one fourth duplicated PDCP PDU and/or RLC SDU associated with the uplink radio bearer and the at least one RLC entity.

In an embodiment, the at least one fourth duplicated PDCP PDU and/or RLC SDU may comprise at least one of one or more PDCP PDUs and/or RLC SDUs associated with the uplink radio bearer that are received from the at least one RLC entity of the first UE and stored in one or more sidelink RLC entities of the relay UE, or one or more PDCP PDUs and/or RLC SDUs associated with the uplink radio bearer that are received from the at least one RLC entity of the first UE and stored in at least one Uu RLC entity of the relay UE.

In an embodiment, the fifth signaling may be received from the network node via the UE-to-network relay path or a UE-to-network direct path.

In an embodiment, the method may further comprise maintaining a mapping table between Uu PDCP PDUs and sidelink RLC PDU in the UE-to-network relay path.

In an embodiment, the mapping table may comprise at least one of a mapping of a Uu PDCP PDU to one or multiple PC5 RLC PDUs, or a mapping of one or multiple Uu PDCP PDUs to a PC5 RLC PDU.

In an embodiment, a Uu PDCP PDU may be identified by a sequence number (SN) value of the Uu PDCP PDU and a sidelink RLC PDU is identified by a SN value of the sidelink RLC PDU in the mapping table.

In an embodiment, an entry corresponding to a Uu PDCP PDU may be added into the mapping table when the Uu PDCP PDU is delivered to a sidelink RLC layer and the entry corresponding to the Uu PDCP PDU is deleted when the sidelink RLC layer indicates to a Uu PDCP layer that the Uu PDCP PDU has been successfully transmitted to a receiver or the Uu PDCP PDU has become invalid when a timer or a counter is expired.

In an embodiment, a signaling between a network node and the first UE may comprise at least one of a RRC signaling, medium access control (MAC) control element (CE), or a layer 1 signaling.

In an embodiment, a signaling between the relay UE and the first UE may comprise at least one of a RRC signaling, MAC CE, or a control PDU of a protocol layer.

In a second aspect of the disclosure, there is provided a method performed by a relay UE. The method may comprise receiving a PDCP PDU of an uplink radio bearer from a first UE. The uplink radio bearer has been activated with PDCP duplication. The method further comprise sending an indication that the PDCP PDU has been successfully delivered to a network node via the relay UE on a UE-to-network relay path to the first UE.

In an embodiment, the PDCP PDU may be delivered to the network node via at least one of a UE-to-network relay path, or a UE-to-network direct path.

In an embodiment, the indication is a RLC status report indicating that the PDCP PDU has been successfully transmitted to the relay UE in a sidelink.

In an embodiment, the indication may indicate the relay UE has received a RLC status report for the PDCP PDU from the network node.

In an embodiment, the method may further comprise receiving a signaling from the first UE. The signaling indicates the relay UE to discard at least one second duplicated PDCP PDU and/or RLC SDU associated with the uplink radio bearer. The method may further comprise discarding at least one second duplicated PDCP PDU and/or RLC SDU associated with the uplink radio bearer.

In an embodiment, the at least one second duplicated PDCP PDU and/or RLC SDU may comprise at least one of one or more PDCP PDUs and/or RLC SDUs associated with the uplink radio bearer that are received from the first UE and stored in at least one sidelink RLC entity, or one or more PDCP PDUs and/or RLC SDUs associated with the uplink radio bearer that are stored in at least one Uu RLC entity.

In an embodiment, the method may further comprise receiving a signaling from the first UE. The signaling indicates the relay UE to discard at least one fourth duplicated PDCP PDU and/or RLC SDU associated with the uplink radio bearer and the at least one RLC entity. The method may further comprise discarding at least one fourth duplicated PDCP PDU and/or RLC SDU associated with the uplink radio bearer and the at least one RLC entity.

In an embodiment, the at least one fourth duplicated PDCP PDU and/or RLC SDU may comprise at least one of one or more PDCP PDUs and/or RLC SDUs associated with the uplink radio bearer that are received from the at least one RLC entity of the first UE and stored in one or more sidelink RLC entities, or one or more PDCP PDUs and/or RLC SDUs associated with the uplink radio bearer that are received from the at least one RLC entity of the first UE and stored in at least one Uu RLC entity.

In an embodiment, the method may further comprise receiving a signaling comprising an identifier of the first UE from the network node. The signaling indicates discarding duplicated PDCP PDUs and/or RLC SDUs associated with the uplink radio bearer. The method may further comprise discarding duplicated PDCP PDUs and/or RLC SDUs associated with the uplink radio bearer.

In an embodiment, the method may further comprise receiving a signaling comprising an identifier of the first UE from the network node. The signaling indicates deactivating at least one RLC entity of the uplink radio bearer in the UE-to-network relay path. The method may further comprise deactivating at least one RLC entity of the uplink radio bearer in the UE-to-network relay path.

In an embodiment, the method may further comprise maintaining a mapping table between Uu PDCP PDUs and sidelink RLC PDU in the UE-to-network relay path.

In an embodiment, the mapping table may comprise at least one of a mapping of a PC5 RLC PDU to one or multiple Uu PDCP PDUs, or a mapping of one or multiple PC5 RLC PDUs to a Uu PDCP PDU.

In an embodiment, a Uu PDCP PDU may be identified by a sequence number (SN) value of the Uu PDCP PDU and a sidelink RLC PDU is identified by a SN value of the sidelink RLC PDU, an identifier of the uplink radio bearer and an identifier of the first UE in the mapping table.

In an embodiment, a signaling between a network node and the relay UE may comprise at least one of a RRC signaling, medium access control (MAC) control element (CE), or a layer 1 signaling.

In an embodiment, a signaling between the relay UE and the first UE may comprise at least one of a RRC signaling, MAC CE, or a control PDU of a protocol layer.

In a third aspect of the disclosure, there is provided a method performed by a network node. The method may comprise: for a downlink radio bearer that has been activated with PDCP duplication, determining that a PDCP PDU has been successfully delivered to a first UE via a relay UE on a UE-to-network relay path. The method may further comprise discarding at least one duplicated PDCP PDU on at least one other UE-to-network path.

In an embodiment, the at least one other UE-to-network path may comprise at least one of a UE-to-network relay path, or a UE-to-network direct path.

In an embodiment, determining that the PDCP PDU has been successfully delivered to the first UE via the relay UE on the UE-to-network relay path may comprise receiving a RLC status report from the relay UE and determining that the PDCP PDU has been successfully delivered to the first UE via the relay UE on the UE-to-network relay path based on the RLC status report. The RLC status report indicates that the PDCP PDU has been successfully transmitted to the relay UE in a Uu link.

In an embodiment, determining that the PDCP PDU has been successfully delivered to the first UE via the relay UE on the UE-to-network relay path may comprise receiving a PDCP status report from the first UE and determining that the PDCP PDU has been successfully delivered to the first UE on the UE-to-network relay path based on the PDCP status report. The PDCP status report indicates that the PDCP PDU has been successfully received by the first UE via the UE-to-network relay path.

In an embodiment, the PDCP status report may be received by the network node when at least one of an upper layer requests a PDCP entity re-establishment, an upper layer requests a PDCP data recovery, an upper layer requests a downlink data switching, an upper layer reconfigures a PDCP entity to release dual active protocol stack (DAPS) and daps-SourceRelease is configured in upper layer, an upper layer determines that a PDCP status report needs to be triggered, a periodic timer is expired, or PDCP duplication has been activated and at least one path for PDCP duplication is the UE-to-network relay path.

In an embodiment, the upper layer may comprise a radio resource control (RRC) layer.

In an embodiment, the PDCP status report is received by the network node via a direct path and/or the UE-to-network relay path.

In an embodiment, determining that the PDCP PDU has been successfully delivered to the first UE via the relay UE on the UE-to-network relay path may comprise receiving a first signaling from the relay UE and determining that the PDCP PDU has been successfully delivered to the first UE via the relay UE on the UE-to-network relay path based on the first signaling. The first signaling indicates that the relay UE has received a RLC status report for the PDCP PDU from the first UE. The RLC status report indicates that the PDCP PDU has been successfully transmitted to the first UE in a sidelink.

In an embodiment, determining that the PDCP PDU has been successfully delivered to the first UE via the relay UE on the UE-to-network relay path may comprise receiving a second signaling from the first UE via a UE-to-network direct path and determining that the PDCP PDU has been successfully delivered to the first UE via the relay UE on the UE-to-network relay path based on the second signaling. The second signaling indicates that the PDCP PDU has been successfully received by the first UE via the UE-to-network relay path.

In an embodiment, the method may further comprise determining to deactivate the PDCP duplication of the downlink radio bearer. The method may further comprise performing at least one of deactivating the PDCP duplication of the downlink radio bearer; sending a third signaling to the first UE; sending a fourth signaling to the first UE; sending a fifth signaling to the relay UE; discarding at least one duplicated PDCP PDU and/or RLC SDU associated with the downlink radio bearer; or sending a sixth signaling to the relay UE. The sixth signaling indicates discarding at least one second duplicated PDCP PDU and/or RLC SDU associated with the downlink radio bearer. The third signaling indicates deactivating PDCP duplication of the downlink radio bearer. The fifth signaling indicates deactivating at least one Uu and PC5 RLC entity for the downlink radio bearer on the UE-to-network relay path. The fourth signaling indicates deactivating at least one sidelink RLC entity for the downlink radio bearer on the UE-to-network relay path.

In an embodiment, the at least one second duplicated PDCP PDU and/or RLC SDU may comprise at least one of one or more PDCP PDUs and/or RLC SDUs associated with the uplink radio bearer that are received from the network node and stored in at least one Uu RLC entity of the relay UE, or one or more PDCP PDUs and/or RLC SDUs associated with the uplink radio bearer that are stored in at least one sidelink RLC entity of the relay UE.

In an embodiment, the method may further comprise maintaining a mapping table between Uu PDCP PDUs and Uu RLC PDU in the UE-to-network relay path.

In an embodiment, the mapping table may comprise at least one of a mapping of a Uu PDCP PDU to one or multiple Uu RLC PDUs, or a mapping of one or multiple Uu PDCP PDUs to a Uu RLC PDU.

In an embodiment, a Uu PDCP PDU may be identified by a sequence number (SN) value of the Uu PDCP PDU and a Uu RLC PDU is identified by a sequence number (SN) value of the Uu RLC PDU in the mapping table.

In an embodiment, an entry corresponding to a Uu PDCP PDU is added into the mapping table when the Uu PDCP PDU is delivered to a Uu RLC layer and the entry corresponding to the Uu PDCP PDU is deleted when the Uu RLC layer indicates to a Uu PDCP layer that the Uu PDCP PDU has been successfully transmitted to a receiver or the Uu PDCP PDU has become invalid when a timer or a counter is expired.

In an embodiment, a signaling between a network node and the first UE may comprise at least one of a RRC signaling, medium access control (MAC) control element (CE), or a layer 1 signaling.

In an embodiment, a signaling between the relay UE and the first UE may comprise at least one of a RRC signaling, MAC CE, or a control PDU of a protocol layer.

In a fourth aspect of the disclosure, there is provided a first user equipment (UE). The first UE may comprise a processor and a memory coupled to the processor. Said memory contains instructions executable by said processor. Said first UE is operative to, for an uplink radio bearer that has been activated with packet data convergence protocol (PDCP) duplication, determine that a PDCP protocol data unit (PDU) has been successfully delivered to a network node via a relay UE on a UE-to-network relay path. Said first UE is further operative to discard at least one duplicated PDCP PDU on at least one other UE-to-network path.

In a fifth aspect of the disclosure, there is provided a relay UE. The relay UE may comprise a processor and a memory coupled to the processor. Said memory contains instructions executable by said processor. Said relay UE is operative to receive a PDCP PDU of an uplink radio bearer from a first UE. The uplink radio bearer has been activated with PDCP duplication. Said relay UE is further operative to send an indication that the PDCP PDU has been successfully delivered to a network node via the relay UE on a UE-to-network relay path to the first UE.

In a sixth aspect of the disclosure, there is provided a network node. The network node may comprise a processor and a memory coupled to the processor. Said memory contains instructions executable by said processor. Said network node is operative to, for a downlink radio bearer that has been activated with PDCP duplication, determine that a PDCP PDU has been successfully delivered to a first UE via a relay UE on a UE- to-network relay path. Said network node is further operative to discard at least one duplicated PDCP PDU on at least one other UE-to-network path.

In a seventh aspect of the disclosure, there is provided a first UE. The first UE may comprise a determining module configured to, for an uplink radio bearer that has been activated with packet data convergence protocol (PDCP) duplication, determine that a PDCP protocol data unit (PDU) has been successfully delivered to a network node via a relay UE on a UE-to-network relay path. The first UE may further comprise a discarding module configured to discard at least one duplicated PDCP PDU on at least one other UE-to-network path.

In an embodiment, the first UE may further comprise a first receiving module configured to receive a third signaling from the network node. The third signaling indicates deactivation of PDCP duplication of the uplink radio bearer.

In an embodiment, the first UE may further comprise a first performing module configured to perform at least one of: deactivating the PDCP duplication for the uplink radio bearer; discarding at least one first duplicated PDCP PDU and/or RLC service data unit (SDU) associated with the uplink radio bearer; or sending a fourth signaling to the relay UE. The fourth signaling indicates the relay UE to discard at least one second duplicated PDCP PDU and/or RLC SDU associated with the uplink radio bearer.

In an embodiment, the first UE may further comprise a second receiving module configured to receive a fifth signaling from the network node. The fifth signaling indicates deactivation of PDCP duplication of the uplink radio bearer for at least one sidelink RLC entity.

In an embodiment, the first UE may further comprise a second performing module configured to perform at least one of: discarding at least one third duplicated PDCP PDU and/or RLC SDU associated with the uplink radio bearer of the at least one RLC entity; or sending a sixth signaling to the relay UE. The sixth signaling indicates the relay UE to discard at least one fourth duplicated PDCP PDU and/or RLC SDU associated with the uplink radio bearer and the at least one RLC entity.

In an embodiment, the first UE may further comprise a maintaining module configured to maintain a mapping table between Uu PDCP PDUs and sidelink RLC PDU in the UE-to-network relay path.

In an eighth aspect of the disclosure, there is provided a relay UE. The relay UE may comprise a first receiving module configured to receive a PDCP PDU of an uplink radio bearer from a first UE. The uplink radio bearer has been activated with PDCP duplication. The relay UE may comprise a sending module configured to send an indication that the PDCP PDU has been successfully delivered to a network node via the relay UE on a UE-to-network relay path to the first UE.

In an embodiment, the relay UE may further comprise a second receiving module configured to receive a signaling from the first UE. The signaling indicates the relay UE to discard at least one second duplicated PDCP PDU and/or RLC SDU associated with the uplink radio bearer. The relay UE may further comprise a first discarding module configured to discard at least one second duplicated PDCP PDU and/or RLC SDU associated with the uplink radio bearer.

In an embodiment, the relay UE may further comprise a third receiving module configured to receive a signaling from the first UE. The signaling indicates the relay UE to discard at least one fourth duplicated PDCP PDU and/or RLC SDU associated with the uplink radio bearer and the at least one RLC entity. The relay UE may further comprise a second discarding module configured to discard at least one fourth duplicated PDCP PDU and/or RLC SDU associated with the uplink radio bearer and the at least one RLC entity.

In an embodiment, the relay UE may further comprise a fourth receiving module configured to receive a signaling comprising an identifier of the first UE from the network node. The signaling indicates discarding duplicated PDCP PDUs and/or RLC SDUs associated with the uplink radio bearer. The relay UE may further comprise a third discarding module configured to discard duplicated PDCP PDUs and/or RLC SDUs associated with the uplink radio bearer.

In an embodiment, the relay UE may further comprise a fifth receiving module configured to receive a signaling comprising an identifier of the first UE from the network node. The signaling indicates deactivating at least one RLC entity of the uplink radio bearer in the UE-to-network relay path. The relay UE may further comprise a deactivating module configured to deactivate at least one RLC entity of the uplink radio bearer in the UE-to-network relay path.

In an embodiment, the relay UE may further comprise a maintaining module configured to maintain a mapping table between Uu PDCP PDUs and sidelink RLC PDU in the UE-to-network relay path.

In a ninth aspect of the disclosure, there is provided a network node. The network node may comprise a first determining module configured to, for a downlink radio bearer that has been activated with PDCP duplication, determine that a PDCP PDU has been successfully delivered to a first UE via a relay UE on a UE-to-network relay path. The network node may further comprise a discarding module configured to discard at least one duplicated PDCP PDU on at least one other UE-to-network path.

In an embodiment, the network node may further comprise a second determining module configured to determine to deactivate the PDCP duplication of the downlink radio bearer.

In an embodiment, the network node may further comprise a performing module configured to perform at least one of: deactivating the PDCP duplication of the downlink radio bearer; sending a third signaling to the first UE; sending a fourth signaling to the first UE; sending a fifth signaling to the relay UE; discarding at least one duplicated PDCP PDU and/or RLC SDU associated with the downlink radio bearer; or sending a sixth signaling to the relay UE. The sixth signaling indicates discarding at least one second duplicated PDCP PDU and/or RLC SDU associated with the downlink radio bearer. The third signaling indicates deactivating PDCP duplication of the downlink radio bearer. The fourth signaling indicates deactivating at least one sidelink RLC entity for the downlink radio bearer on the UE-to-network relay path. The fifth signaling indicates deactivating at least one Uu and PC RLC entity for the downlink radio bearer on the UE-to-network relay path.

In an embodiment, the network node may further comprise a maintaining module configured to maintain a mapping table between Uu PDCP PDUs and Uu RLC PDU in the UE-to-network relay path.

In another aspect of the disclosure, there is provided a computer program product comprising instructions which when executed by at least one processor, cause the at least one processor to perform the method according to any one of the first, second and third aspects.

In another aspect of the disclosure, there is provided a computer-readable storage medium storing instructions which when executed by at least one processor, cause the at least one processor to perform the method according to any one of the first, second and third aspects.

In another aspect of the disclosure, there is provided a communication system including a host computer. The host computer includes processing circuitry configured to provide user data and a communication interface configured to forward the user data to a cellular network for transmission to a terminal device. The cellular network includes the network node above mentioned, and/or the terminal device (such as the first UE and the relay UE above mentioned).

In embodiments of the present disclosure, the system further includes the terminal device. The terminal device is configured to communicate with the network node.

In embodiments of the present disclosure, the processing circuitry of the host computer is configured to execute a host application, thereby providing the user data; and the terminal device includes processing circuitry configured to execute a client application associated with the host application.

In another aspect of the disclosure, there is provided a communication system including a host computer and a network node. The host computer includes a communication interface configured to receive user data originating from a transmission from a terminal device. The transmission is from the terminal device to the network node. The network node is above mentioned, and/or the terminal device is above mentioned first UE and relay UE.

In embodiments of the present disclosure, the processing circuitry of the host computer is configured to execute a host application. The terminal device is configured to execute a client application associated with the host application, thereby providing the user data to be received by the host computer.

In another aspect of the disclosure, there is provided a method implemented in a communication system which may include a host computer, a network node and a terminal device. The method may comprise providing user data at the host computer. Optionally, the method may comprise, at the host computer, initiating a transmission carrying the user data to the terminal device via a cellular network comprising the network node which may perform any step of the method according to the third aspect of the present disclosure.

In another aspect of the disclosure, there is provided a communication system including a host computer. The host computer may comprise processing circuitry configured to provide user data, and a communication interface configured to forward the user data to a cellular network for transmission to a terminal device. The cellular network may comprise a network node having a radio interface and processing circuitry. The network node's processing circuitry may be configured to perform any step of the method according to the third aspect of the present disclosure.

In another aspect of the disclosure, there is provided a method implemented in a communication system which may include a host computer, a network node and a terminal device. The method may comprise providing user data at the host computer. Optionally, the method may comprise, at the host computer, initiating a transmission carrying the user data to the terminal device via a cellular network comprising the network node. The terminal device may perform any step of the methods according to the first and second aspects of the present disclosure.

In another aspect of the disclosure, there is provided a communication system including a host computer. The host computer may comprise processing circuitry configured to provide user data, and a communication interface configured to forward user data to a cellular network for transmission to a terminal device. The terminal device may comprise a radio interface and processing circuitry. The terminal device's processing circuitry may be configured to perform any step of the methods according to the first and second aspects of the present disclosure.

In another aspect of the disclosure, there is provided a method implemented in a communication system which may include a host computer, a network node and a terminal device. The method may comprise, at the host computer, receiving user data transmitted to the network node from the terminal device which may perform any step of the methods according to the first and second aspects of the present disclosure.

In another aspect of the disclosure, there is provided a communication system including a host computer. The host computer may comprise a communication interface configured to receive user data originating from a transmission from a terminal device to a network node. The terminal device may comprise a radio interface and processing circuitry. The terminal device's processing circuitry may be configured to perform any step of the methods according to the first and second aspects of the present disclosure.

In another aspect of the disclosure, there is provided a method implemented in a communication system which may include a host computer, a network node and a terminal device. The method may comprise, at the host computer, receiving, from the network node, user data originating from a transmission which the network node has received from the terminal device. The network node may perform any step of the method according to the third aspect of the present disclosure.

In another aspect of the disclosure, there is provided a communication system which may include a host computer. The host computer may comprise a communication interface configured to receive user data originating from a transmission from a terminal device to a network node. The network node may comprise a radio interface and processing circuitry. The network node's processing circuitry may be configured to perform any step of the method according to the third aspect of the present disclosure.

Embodiments herein may provide many advantages, of which a non-exhaustive list of examples follows. In some embodiments herein, it can avoid redundant duplicate PDUs to be transmitted. In some embodiments herein, it can ensure PDCP duplication to work properly in Uu and SL mixed multi-path scenarios. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1a illustrates a protocol stack of user plane for L2 UE-to-Network Relay UE;

FIG. 1b illustrates a protocol stack of control plane for L2 UE-to-Network Relay UE;

FIG. 1c illustrates architecture model using a ProSe 5G UE-to-Network Relay;

FIG. 1d illustrates a protocol stack for Layer-3 UE-to-Network Relays;

FIG. 1e illustrates an example of packet duplication;

FIG. 2a schematically shows a high level architecture in the fifth generation network according to an embodiment of the present disclosure;

FIG. 2b schematically shows system architecture in a 4G network according to an embodiment of the present disclosure;

FIG. 3a shows a flowchart of a method according to an embodiment of the present disclosure;

FIG. 3b shows a flowchart of a method according to another embodiment of the present disclosure;

FIG. 3c shows a flowchart of a method according to another embodiment of the present disclosure;

FIG. 3d shows a flowchart of a method according to another embodiment of the present disclosure;

FIG. 4a shows a flowchart of a method according to another embodiment of the present disclosure;

FIG. 4b shows a flowchart of a method according to another embodiment of the present disclosure;

FIG. 4c shows a flowchart of a method according to another embodiment of the present disclosure;

FIG. 4d shows a flowchart of a method according to another embodiment of the present disclosure;

FIG. 4e shows a flowchart of a method according to another embodiment of the present disclosure;

FIG. 4f shows a flowchart of a method according to another embodiment of the present disclosure;

FIG. 5a shows a flowchart of a method according to another embodiment of the present disclosure;

FIG. 5b shows a flowchart of a method according to another embodiment of the present disclosure;

FIG. 6 shows a flowchart of a method according to another embodiment of the present disclosure;

FIG. 7 is a block diagram showing an apparatus suitable for practicing some embodiments of the disclosure;

FIG. 8a is a block diagram showing a first UE according to an embodiment of the disclosure;

FIG. 8b is a block diagram showing a relay UE according to an embodiment of the disclosure;

FIG. 8c is a block diagram showing a network node according to an embodiment of the disclosure;

FIG. 9 is a schematic showing a wireless network in accordance with some embodiments;

FIG. 10 is a schematic showing a user equipment in accordance with some embodiments;

FIG. 11 is a schematic showing a virtualization environment in accordance with some embodiments;

FIG. 12 is a schematic showing a telecommunication network connected via an intermediate network to a host computer in accordance with some embodiments;

FIG. 13 is a schematic showing a host computer communicating via a base station with a user equipment over a partially wireless connection in accordance with some embodiments;

FIG. 14 is a schematic showing methods implemented in a communication system including a host computer, a base station and a user equipment in accordance with some embodiments;

FIG. 15 is a schematic showing methods implemented in a communication system including a host computer, a base station and a user equipment in accordance with some embodiments;

FIG. 16 is a schematic showing methods implemented in a communication system including a host computer, a base station and a user equipment in accordance with some embodiments; and

FIG. 17 is a schematic showing methods implemented in a communication system including a host computer, a base station and a user equipment in accordance with some embodiments.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced (LTE-A), wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols cither currently known or to be developed in the future.

The term “network node” or “network node” refers to any suitable network function (NF) which can be implemented in a network element (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and Mobility Management Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The network node may be an access network node with accessing function in a communication network via which a terminal device accesses to the network and receives services therefrom. The access network node may include a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), an Integrated Access and Backhaul (IAB) node, a remote radio head (RRH), a relay, a low power node such as a femto, a pico, and so forth.

Yet further examples of the access network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP' LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for case of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

### NR Sidelink

NR sidelink communication was specified by 3GPP Release 16. The NR SL is an evolution of the LTE sidelink, in particular of the features introduced in 3GPP Release 14 and 3GPP Release 15 for vehicle-to-everything (V2X) communication. Some of the most relevant features of the NR sidelink are the following:
Support for unicast and groupcast transmissions, in addition to broadcast transmissions, which were already supported in LTE.
Support for HARQ (Hybrid Automatic Repeat Request) feedback over the SL for unicast and groupcast. This feedback is conveyed by the receiver UE to the transmitted UE using the physical sidelink feedback channel (PSFCH). This functionality is new in NR compared to LTE.
To alleviate resource collisions among different sidelink transmissions launched by different UEs, it enhances channel sensing and resource selection procedures, which also lead to a new design of physical channels carrying the sidelink control information (SCI). The new design of the SCI simplifies coexistence between releases by grouping together all the information related to resource allocation (which is critical for coexistence) in a single channel with a robust, predefined format. Other control information is carried by other means, in a more flexible manner.
Grant-free transmissions, which are supported in NR uplink transmissions, are also provided in NR sidelink transmissions, to improve the latency performance.
To achieve a high connection density, congestion control and thus the QoS (Quality of Service) management is supported in NR sidelink transmissions.

### NR SL Physical Channels

In NR sidelink, the following physical layer (PHY) channels are defined:
PSCCH (Physical Sidelink Common Control Channel): This channel carries sidelink control information (SCI) including part of the scheduling assignment (SA) that allows a receiver to further process and decode the corresponding PSSCH (e.g., demodulation reference signal (DMRS) pattern and antenna port, MCS (Modulation and Coding Scheme), etc.). In addition, the PSCCH indicates future reserved resources. This allows a RX (receiver) to sense and predict the utilization of the channel in the future. This sensing information is used for the purpose of UE-autonomous resource allocation (Mode 2), which is described below.
PSSCH (Physical Sidelink Shared Channel): The PSSCH is transmitted by a sidelink transmitter UE, which conveys sidelink transmission data (i.e., the SL shared channel SL-SCH), and a part of the sidelink control information (SCI). In addition, higher layer control information may be carried using the PSSCH (e.g., MAC (medium access control) CEs (control element), radio resource control (RRC) signaling, etc.). For example, channel state information (CSI) is carried in the medium access control (MAC) control element (CE) over the PSSCH instead of the PSFCH.
PSFCH (Physical Sidelink feedback channel): The PSFCH is transmitted by a sidelink receiver UE for unicast and groupcast. It conveys the SL HARQ acknowledgement, which may consist of ACK/NACK (Acknowledgement/Negative Acknowledgement) (used for unicast and groupcast option 2) or NACK-only (used for groupcast option 1).
Physical Sidelink Broadcast Channel (PSBCH): The PSBCH conveys information related to synchronization, such as the direct frame number (DFN), indication of the slot and symbol level time resources for sidelink transmissions, in-coverage indicator, etc. The SSB is transmitted periodically at every 160 ms. The PSBCH is transmitted along with the S-PSS/S-SSS (Sidelink Primary/Secondary Synchronization Signal) as a sidelink synchronization signal block (S-SSB).

Sidelink Primary/Secondary Synchronization Signal (S-PSS/S-SSS) are used by UEs to establish a common timing references among UEs in the absence of another reference such as GNSS time of NW time.

Along with the different physical channels, reference signals (RS) are transmitted for different purposes, including demodulation (DM-RS), phase tracking RS (PT-RS), or RS for channel state information acquisition (CSI-RS).

Another new feature is the two-stage sidelink control information (SCI). A first part (first stage) of the SCI is sent on the PSCCH. This part is used for channel sensing purposes (including the reserved time-frequency resources for transmissions, demodulation reference signal (DMRS) pattern and antenna port, etc.) and can be read by all UEs while the remaining part (second stage) of the SCI carries the remaining scheduling and control information such as a 8-bits source identity (ID) and a 16-bits destination ID, NDI (New Data Indicator), RV (Redundancy Version) and HARQ process ID is sent on the PSSCH to be decoded by the receiver UE.

### Resource Allocation

NR sidelink supports the following two modes of resource allocation:
Mode 1: Sidelink resources are scheduled by a gNB.
Mode 2: The UE autonomously selects sidelink resources from a (pre-) configured sidelink resource pool. To avoid collisions between UEs a procedure based on the channel sensing and resource reservation is used.

An in-coverage UE can be configured by a gNB to use Mode 1 or Mode 2. For the out-of-coverage UE, only Mode 2 can be used.

Like in LTE, scheduling over the sidelink in NR is done in different ways for Mode 1 and Mode 2.

In Mode 1, the grant is provided by the gNB. The following two kinds of grants are supported:
Dynamic grants are provided for one or multiple transmissions of a single packet (i.e., transport block). When the traffic to be sent over sidelink arrives at a transmitter UE (i.e., at the corresponding TX (transmitting) buffer), the UE initiates the four-message exchange procedure to request sidelink resources from a gNB (SR (Scheduling Request) on UL (uplink), grant, BSR (Buffer Status Report) on UL, grant for data on SL sent to UE). A gNB indicates the resource allocation for the PSCCH and the PSSCH in the downlink control information (DCI) conveyed by PDCCH (Physical Downlink Control Channel) with CRC (Cyclic Redundancy Check) scrambled with the SL-RNTI (Radio Network Temporary Identity) of the corresponding UE. A UE receiving such a DCI, assumes that it has been provided a SL dynamic grant only if the detects that the CRC of DCI has been scrambled with its SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single TB. As a result, this kind of grant is suitable for traffic with a loose latency requirement.
Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. This kind of grant is also known as grant-free transmissions.

Note that only the transmitter UE is scheduled by the gNB. The receiver UE does not receive any information directly from the gNB. Instead, it is scheduled by the transmitter UE by means of the SCI. Therefore, a receiver UE should perform blind decoding to identify the presence of PSCCH and find the resources for the PSSCH through the SCI.

In Mode 2 resource allocation, the grant is generated by the UE itself. When traffic arrives at a transmitter UE (i.e., at the corresponding TX buffer), this transmitter autonomously selects resources for the PSCCH and the PSSCH. To further enhance the probability of successful TB (Transport Block) decoding at one shot and thus suppress the probability to perform retransmissions, a transmitter UE may repeat the TB transmission along with the initial TB transmission. These retransmissions may be triggered by the corresponding SL HARQ feedback or may be sent blindly by the transmitter UE. In either case, to minimize the probability of collision for potential retransmissions, the transmitter UE may also reserve the corresponding resources for PSCCH/PSSCH for retransmissions. That is, the transmitter UE selects resources for:
1) The PSCCH/PSSCH corresponding to the first transmission.
2) The PSCCH/PSCCH corresponding to the retransmissions. Resources for up to 2 retransmissions may be reserved. These reserved resources are always used in case of blind retransmissions. If SL HARQ feedback is used, the used of the reserved resources is conditional on a negative SL HARQ acknowledgement.

Since each transmitter UE in sidelink transmissions should autonomously select resources for its own transmissions, preventing the different transmitter UEs from selecting the same resources turns out to be a critical issue in Mode 2. A particular resource selection procedure is therefore imposed to Mode 2 based on channel sensing. The channel sensing algorithm involves detecting the reservations transmitted by other UEs and performing power measurements (i.e., reference signal received power or RSRP) on the incoming transmissions.

### NR Sidelink Layer 2 (L2) UE-to-Network Relay

In 3GPP TR 23.752 V17.0.0, the disclosure of which is incorporated by reference herein in its entirety, the layer-2 based UE-to-Network relay is described.

The protocol architecture supporting a L2 UE-to-Network Relay UE is provided.

The L2 UE-to-Network Relay UE provides forwarding functionality that can relay any type of traffic over the PC5 link.

The L2 UE-to-Network Relay UE provides the functionality to support connectivity to the 5GS (5G system) for Remote UEs. A UE is considered to be a Remote UE if it has successfully established a PC5 link to the L2 UE-to-Network Relay UE. A Remote UE can be located within NG-RAN coverage or outside of NG-RAN coverage.

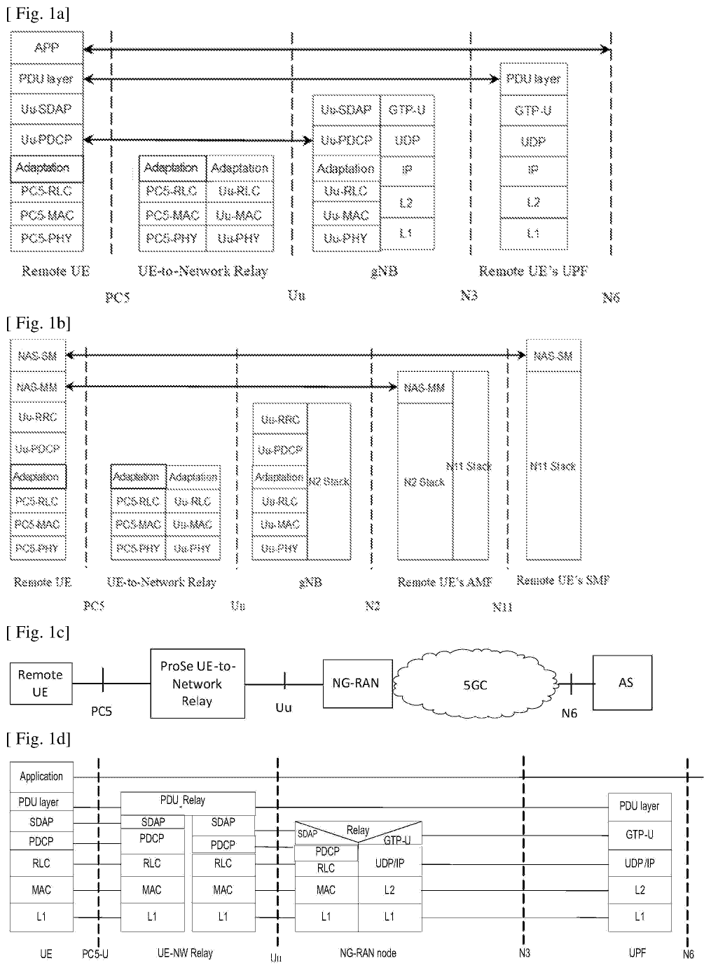

FIG. 1a illustrates a protocol stack of user plane for L2 UE-to-Network Relay UE, which is same as Figure A. 2.1-1 of 3GPP TR 23.752 V17.0.0. APP denotes application. PDU denotes Protocol Data Unit. SDAP denotes Service Data Adaptation Protocol. RLC denotes Radio Link Control. MAC denotes Medium Access Control. PHY denotes physical. L2 denotes layer 2. The PDU layer corresponds to the PDU carried between the Remote UE and the Data Network (DN) over the PDU session. It is important to note that the two endpoints of the PDCP link are the Remote UE and the gNB. The relay function is performed below PDCP. This means that data security is ensured between the Remote UE and the gNB without exposing raw data at the UE-to-Network Relay UE.

The adaptation rely layer within the UE-to-Network Relay UE can differentiate between signaling radio bearers (SRBs) and data radio bearers (DRBs) for a particular Remote UE. The adaption relay layer is also responsible for mapping PC5 traffic to one or more DRBs of the Uu.

FIG. 1b illustrates a protocol stack of control plane for L2 UE-to-Network Relay UE, which is same as Figure A. 2.2-1 of 3GPP TR 23.752 V17.0.0. NAS denotes Non-Access Stratum. SM denotes Session Management. MM denotes Mobility Management. The NAS messages are transparently transferred between the Remote UE and 5G-AN (access network) over the Layer 2 UE-to-Network Relay UE using:

The NAS messages are transparently transferred between the Remote UE and 5G-AN (access network) over the Layer 2 UE-to-Network Relay UE using:
PDCP end-to-end connection where the role of the UE-to-Network Relay UE is to relay the PDUs over the signaling radio bear without any modifications.
N2 connection between the 5G-AN and AMF over N2.
N11 connection AMF and SMF over N11.

The role of the UE-to-Network Relay UE is to relay the PDUs from the signaling radio bearer without any modifications.

### NR SL Layer 3 (L3) UE-to-Network Relay

In the In 3GPP TR 23.752 V17.0.0, clause 6.6, the layer-3 based UE-to-Network relay is described.

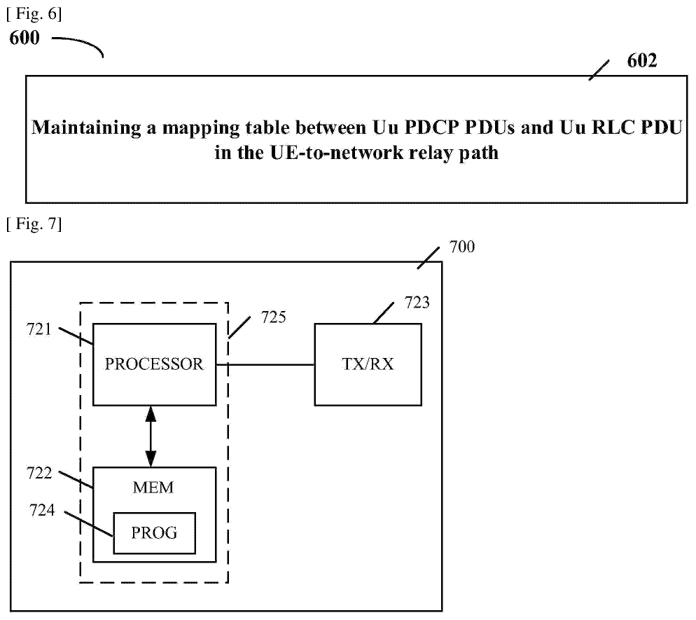

FIG. 1c illustrates architecture model using a ProSe 5G UE-to-Network Relay, which is same as FIG. 6.6.1-1 of 3GPP TR 23.752 V17.0.0.

The ProSe 5G UE-to-Network Relay entity provides the functionality to support connectivity to the network for Remote UEs. It can be used for both public safety services and commercial services (e.g. interactive service).

A UE is considered to be a Remote UE for a certain ProSe UE-to-Network relay if it has successfully established a PC5 link to this ProSe 5G UE-to-Network Relay. A Remote UE can be located within NG-RAN coverage or outside of NG-RAN coverage.

The ProSe 5G UE-to-Network Relay shall relay unicast traffic (UL (uplink) and DL (downlink)) between the Remote UE and the network. The ProSe UE-to-Network Relay shall provide generic function that can relay any IP traffic.

One-to-one Direct Communication is used between Remote UEs and ProSe 5G UE-to-Network Relays for unicast traffic as specified in solutions for Key Issue #2 in the 3GPP TR 23.752 V17.0.0.

FIG. 1d illustrates a protocol stack for Layer-3 UE-to-Network Relays, which is same as FIG. 6.6.1-2 of 3GPP TR 23.752 V17.0.0.

Hop-by-hop security is supported in the PC5 link and Uu link. If there are requirements beyond hop-by-hop security for protection of Remote UE's traffic, security over IP layer needs to be applied.

### Packet Duplication in NR

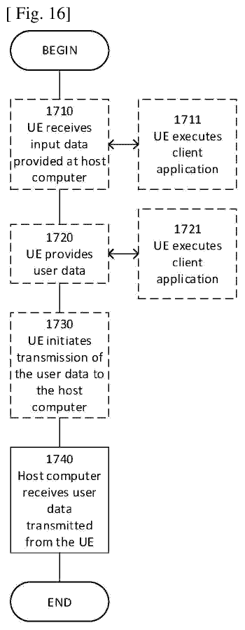

FIG. 1e illustrates an example of packet duplication, which is same as FIG. 16.1.3-1 of 3GPP TS 38.300 V16.8.0, the disclosure of which is incorporated by reference herein in its entirety.

As described in clause 16.1.3 of TS 38.300 V16.8.0, when duplication is configured for a radio bearer by RRC, at least one secondary RLC entity is added to the radio bearer to handle the duplicated PDCP PDUs, where the logical channel corresponding to the primary RLC entity is referred to as the primary logical channel, and the logical channel corresponding to the secondary RLC entity (ies), the secondary logical channel(s). All RLC entities have the same RLC mode. Duplication at PDCP therefore consists in submitting the same PDCP PDUs multiple times: once to each activated RLC entity for the radio bearer. With multiple independent transmission paths, packet duplication therefore increases reliability and reduces latency and is especially beneficial for URLLC services.

NOTE: PDCP control PDUs are not duplicated and always submitted to the primary RLC entity.

When configuring duplication for a DRB, RRC also sets the state of PDCP duplication (either activated or deactivated) at the time of (re-) configuration. After the configuration, the PDCP duplication state can then be dynamically controlled by means of a MAC control element and in DC (dual connectivity), the UE applies the MAC CE commands regardless of their origin (MCG (Master Cell group) or SCG (Secondary Cell group)). When duplication is configured for an SRB the state is always active and cannot be dynamically controlled. When configuring duplication for a DRB with more than one secondary RLC entity, RRC also sets the state of each of them (i.e. either activated or deactivated). Subsequently, a medium access control (MAC) control element (CE) can be used to dynamically control whether each of the configured secondary RLC entities for a DRB should be activated or deactivated, i.e. which of the RLC entities shall be used for duplicate transmission. Primary RLC entity cannot be deactivated. When duplication is deactivated for a DRB, all secondary RLC entities associated to this DRB are deactivated. When a secondary RLC entity is deactivated, it is not re-established, the HARQ buffers are not flushed, and the transmitting PDCP entity should indicate to the secondary RLC entity to discard all duplicated PDCP PDUs.

When activating duplication for a DRB, NG-RAN should ensure that at least one serving cell is activated for each logical channel associated with an activated RLC entity of the DRB; and when the deactivation of Scells (Secondary Cells) leaves no serving cells activated for a logical channel of the DRB, NG-RAN (next generation radio access network) should ensure that duplication is also deactivated for the RLC entity associated with the logical channel.

When duplication is activated, the original PDCP PDU and the corresponding duplicate(s) shall not be transmitted on the same carrier. The logical channels of a radio bearer configured with duplication can either belong to the same MAC entity (referred to as CA (Carrier Aggregation) duplication) or to different ones (referred to as DC (Dual Connectivity) duplication). CA duplication can also be configured in either or both of the MAC entities together with DC duplication when duplication over more than two RLC entities is configured for the radio bearer. In CA duplication, logical channel mapping restrictions are used in a MAC entity to ensure that the different logical channels of a radio bearer in the MAC entity are not sent on the same carrier. When CA duplication is configured for an SRB, one of the logical channels associated to the SRB is mapped to SpCell.

When CA duplication is deactivated for a DRB in a MAC entity (i.e. none or only one of RLC entities of the DRB in the MAC entity remains activated), the logical channel mapping restrictions of the logical channels of the DRB are lifted for as long as CA duplication remains deactivated for the DRB in the MAC entity.

When an RLC entity acknowledges the transmission of a PDCP PDU, the PDCP entity shall indicate to the other RLC entity (ies) to discard it. In addition, in case of CA duplication, when an RLC entity restricted to only SCell(s) reaches the maximum number of retransmissions for a PDCP PDU, the UE informs the gNB but does not trigger radio link failure (RLF).

### Duplicate PDU Discard at PDCP Layer

As described in clause 5.11.2 of TS 38.323 V16.6.0, the disclosure of which is incorporated by reference herein in its entirety, for the PDCP entity configured with pdcp-Duplication, the transmitting PDCP entity shall:
if the successful delivery of a PDCP Data PDU is confirmed by one of the associated AM RLC entities:
indicate to the other AM RLC entities to discard the duplicated PDCP Data PDU;
if the deactivation of PDCP duplication is indicated for the DRB:
indicate to the RLC entities other than the primary RLC entity to discard all duplicated PDCP Data PDUs;
if the deactivation of PDCP duplication is indicated for at least one associated RLC entities:
indicate to the RLC entities deactivated for PDCP duplication to discard all duplicated PDCP Data PDUs.

### SDU Discard at RLC Layer

As described in clause 5.4 of TS 38.322 V16.2.0, when indicated from upper layer (i.e. PDCP) to discard a particular RLC service data unit (SDU), the transmitting side of an Acknowledge Mode (AM) RLC entity or the transmitting UM (Un-Acknowledge Mode (UM)) RLC entity shall discard the indicated RLC SDU, if neither the RLC SDU nor a segment thereof has been submitted to the lower layers. The transmitting side of an AM RLC entity shall not introduce an RLC SN (Sequence Number) gap when discarding an RLC SDU.

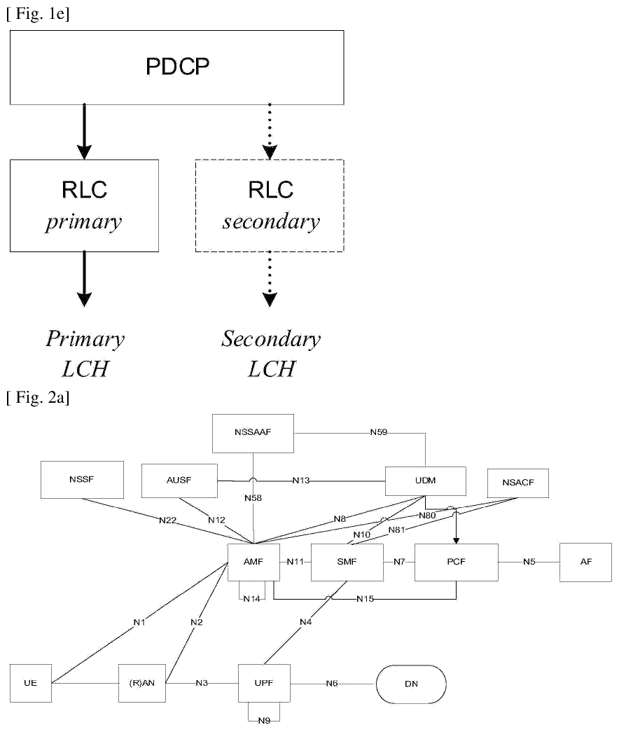

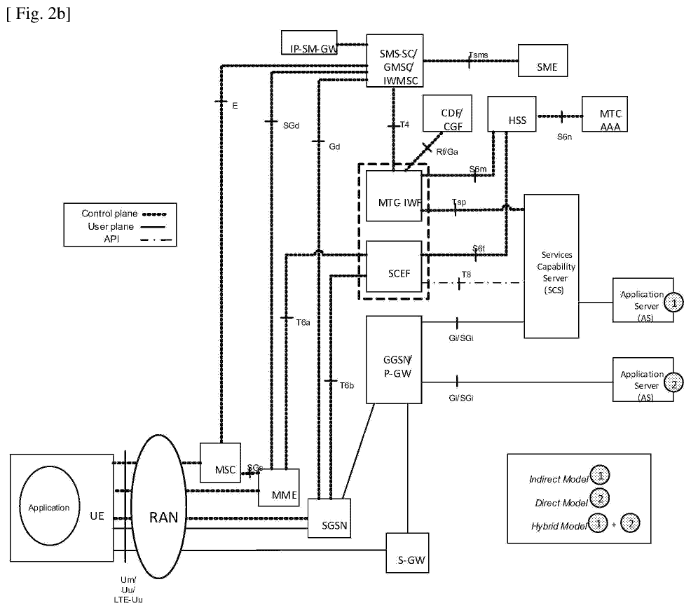

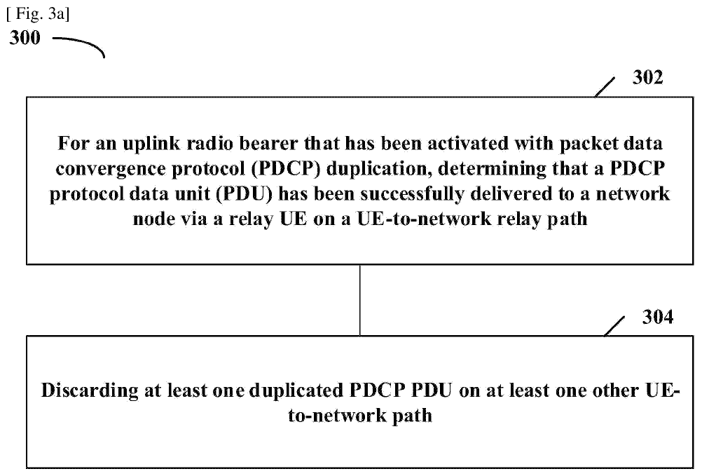

Although the subject matter described herein may be implemented in any appropriate type of system using any suitable components, the embodiments disclosed herein are described in relation to a communication system complied with the exemplary system architectures illustrated in FIGS. 2a-2b. For simplicity, the system architectures of FIGS. 2a-2b only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

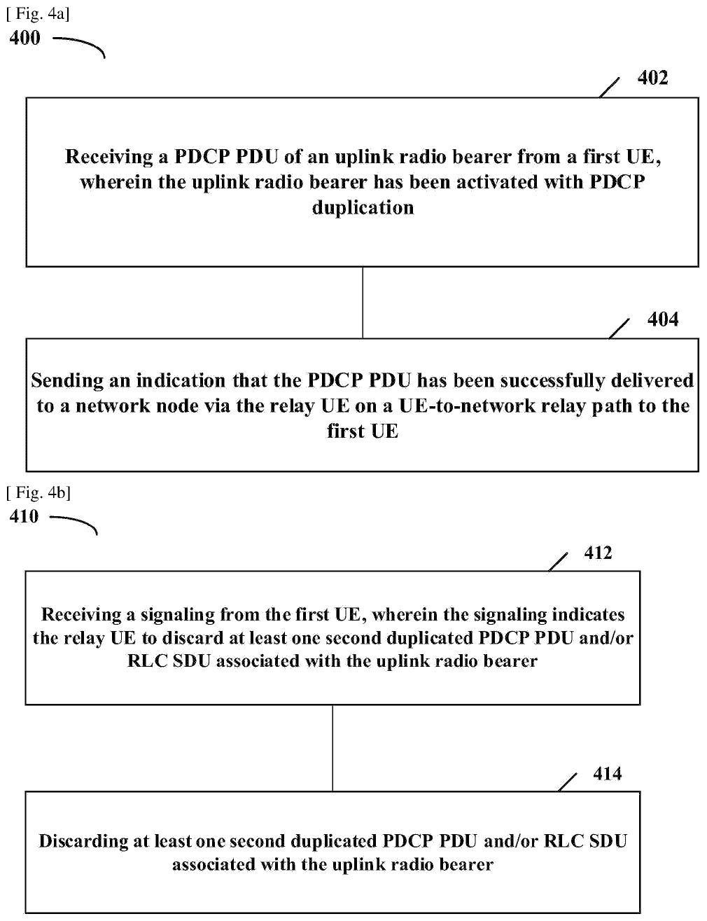

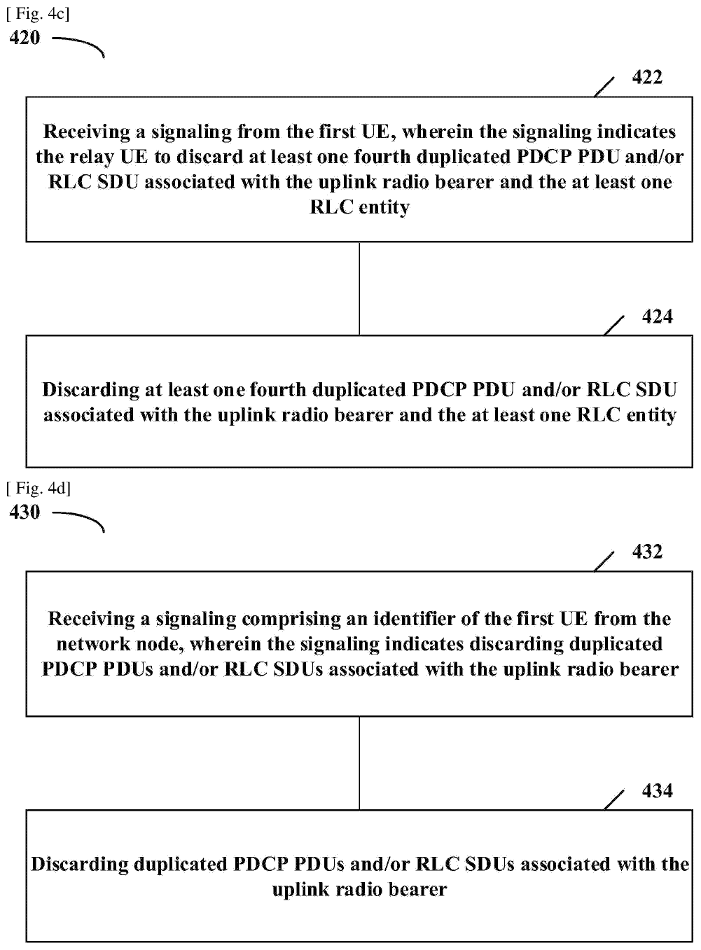

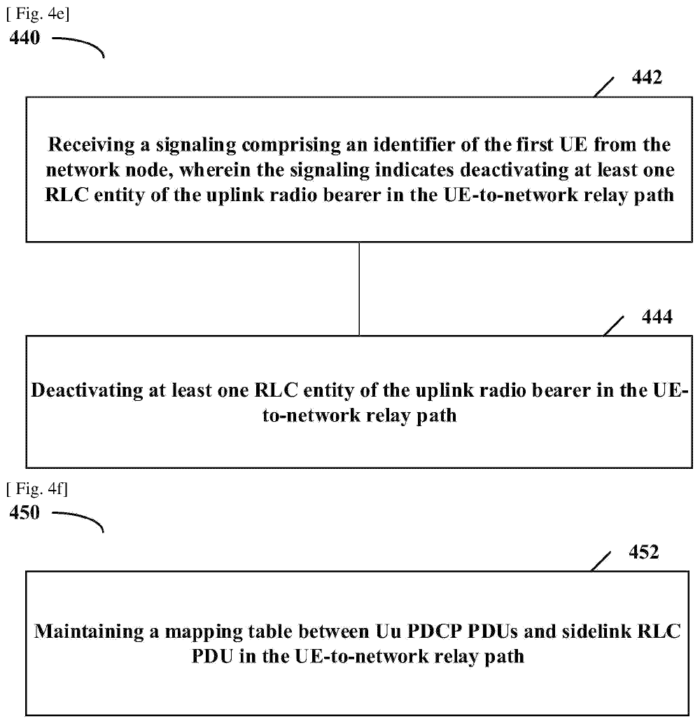

FIG. 2a schematically shows a high level architecture in the fifth generation network according to an embodiment of the present disclosure. For example, the fifth generation network may be 5GS. The architecture of FIG. 2a is same as FIG. 4.2.3-2 as described in 3GPP TS 23.501 V17.2.0, the disclosure of which is incorporated by reference herein in its entirety. The system architecture of FIG. 2a may comprise some exemplary elements such as AUSF, AMF, DN (data network), NEF, NRF, NSSF, PCF, SMF, UDM, UPF, AF, UE, (R) AN, SCP (Service Communication Proxy), NSSAAF (Network Slice-Specific Authentication and Authorization Function), NSACF (Network Slice Admission Control Function), etc.

In accordance with an exemplary embodiment, the UE can establish a signaling connection with the AMF over the reference point N1, as illustrated in FIG. 2a. This signaling connection may enable NAS (Non-access stratum) signaling exchange between the UE and the core network, comprising a signaling connection between the UE and the (R) AN and the N2 connection for this UE between the (R) AN and the AMF. The (R) AN can communicate with the UPF over the reference point N3. The UE can establish a protocol data unit (PDU) session to the DN (data network, e.g. an operator network or Internet) through the UPF over the reference point N6.

As further illustrated in FIG. 2a, the exemplary system architecture also contains some reference points such as N1, N2, N3, N4, N6, N9, N15, etc., which can support the interactions between NF services in the NFs. For example, these reference points may be realized through corresponding NF service-based interfaces and by specifying some NF service consumers and providers as well as their interactions in order to perform a particular system procedure. The AM related policy is provided by PCF to AMF for a registered UE via N15 interface. AMF can get AM policy during AM Policy Association Establishment/Modification procedure.

Various NFs shown in FIG. 2a may be responsible for functions such as session management, mobility management, authentication, security, etc. The AUSF, AMF, DN, NEF, NRF, NSSF, PCF, SMF, UDM, UPF, AF, UE, (R) AN, SCP, NSACF may include the functionality for example as defined in clause 6.2 of 3GPP TS 23.501 V17.2.0.

FIG. 2b schematically shows system architecture in a 4G network according to an embodiment of the present disclosure, which is the same as FIG. 4.2-1a of 3GPP TS 23.682 V17.2.0, the disclosure of which is incorporated by reference herein in its entirety. The system architecture of FIG. 2b may comprise some exemplary elements such as Services Capability Server (SCS), Application Server (AS), SCEF (Service Capability Exposure Function), HSS, UE, RAN (Radio Access Network), SGSN (Serving GPRS (General Packet Radio Service) Support Node), MME, MSC (Mobile Switching Centre), S-GW (Serving Gateway), GGSNP-GW (Gateway GPRS Support Node/PDN (Packet Data Network) Gateway), MTC-IWF (Machine Type Communications-InterWorking Function) CDF/CGF (Charging Data Function/Charging Gateway Function), MTC-AAA (Machine Type Communications-authentication, authorization and accounting), SMS-SC/GMSC/IWMSC (Short Message Service-Service Centre/Gateway MSC/InterWorking MSC) IP-SM-GW (Internet protocol Short Message Gateway). The network elements and interfaces as shown in FIG. 2b may be same as the corresponding network elements and interfaces as described in 3GPP TS 23.682 V17.2.0.

The system architecture shows the architecture for a UE used for MTC connecting to the 3GPP network (UTRAN (Universal Terrestrial Radio Access Network), E-UTRAN (Evolved UTRAN), GERAN (GSM EDGE (Enhanced Data rates for GSM Evolution) Radio Access Network), etc.) via the Um/Uu/LTE-Uu interfaces. The system architecture also shows the 3GPP network service capability exposure to SCS and AS.

As further illustrated in FIG. 2b, the exemplary system architecture also contains various reference points.
Tsms: Reference point used by an entity outside the 3GPP network to communicate with UEs used for MTC via SMS (Short Message Service).
Tsp: Reference point used by a SCS to communicate with the MTC-IWF related control plane signalling.
T4: Reference point used between MTC-IWF and the SMS-SC in the HPLMN.
T6a: Reference point used between SCEF and serving MME.
T6b: Reference point used between SCEF and serving SGSN.
T8: Reference point used between the SCEF and the SCS/AS.
S6m: Reference point used by MTC-IWF to interrogate HSS/HLR (Home Location Register).
S6n: Reference point used by MTC-AAA to interrogate HSS/HLR.
S6t: Reference point used between SCEF and HSS.
SGs: Reference point used between MSC and MME.
Gi/SGi: Reference point used between GGSN/P-GW and application server and between GGSNP-GW and SCS.
Rf/Ga: Reference point used between MTC-IWF and CDF/CGF.
Gd: Reference point used between SMS-SC/GMSC/IWMSC and SGSN.
SGd: Reference point used between SMS-SC/GMSC/IWMSC and MME.
E: Reference point used between SMS-SC/GMSC/IWMSC and MSC.

The end-to-end communications, between the MTC Application in the UE and the MTC Application in the external network, uses services provided by the 3GPP system, and optionally services provided by a Services Capability Server (SCS).

The MTC Application in the external network is typically hosted by an Application Server (AS) and may make use of an SCS for additional value added services. The 3GPP system provides transport, subscriber management and other communication services including various architectural enhancements motivated by, but not restricted to, MTC (e.g. control plane device triggering).

Different models are foreseen for machine type of traffic in what relates to the communication between the AS and the 3GPP system and based on the provider of the SCS. The different architectural models that are supported by the Architectural Reference Model include the Direct Model, Indirect Model and Hybrid Model as described in 3GPP TS 23.682 V17.2.0.

A term “node” is used, which can be a network node or a UE. Examples of network nodes are NodeB, base station (BS), multi-standard radio (MSR) radio node such as MSR BS, eNodeB, gNodeB. MeNB (Master eNB), SeNB (Secondary eNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN (Centralized-RAN), access point (AP), transmission points, transmission nodes, Remote Radio Unit (RRU), Remote Radio Head (RRH), nodes in distributed antenna system (DAS), core network node (e.g. MSC, MME etc), O&M (Operations &Maintenance), Operation Support System (OSS), Self-Organizing Networks (SON), positioning node (e.g. E-SMLC (Evolved Serving Mobile Location Centre)), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, PDA, Tablet, mobile terminals, smart phone, laptop embedded equipment (LEE), laptop mounted equipment (LME), USB dongles etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP) etc.

The term radio access technology, or RAT, may refer to any RAT e.g. UTRA, E-UTRA, narrow band internet of things (NB-IoT), WiFi, Bluetooth, next generation RAT, New Radio (NR), 4G, 5G, etc. Any of the equipment denoted by the terminology node, network node or radio network node may be capable of supporting a single or multiple RATs.

Further, the term “direct path” is used to stand for a direct connection from a remote UE to a gNB (e.g., via NR air interface) and we use the term “indirect path” to stand for an indirect connection between a remote UE and a gNB via an intermediate node also known as relay UE. In the below embodiments, we assume an indirect path contains two hops i.e., PC5 hop between remote UE and relay UE, and Uu hop between relay UE and gNB. however, the embodiments are not limited to two hops. For an indirect path containing more than two hops, the embodiments are also applicable.

The embodiments are described in the context of NR, i.e., remote UE and relay UE are deployed in a same or different NR cell. The embodiments are applicable to relay scenarios including UE to network (U2N) relay where the link between remote UE and relay UE may be based on LTE sidelink or NR sidelink, the Uu connection between relay UE and base station may be LTE Uu or NR Uu. The connection between remote UE and relay UE is also not limited to sidelink. Any short-range communication technology such as Wifi is equally applicable.

The embodiments are also applicable to a relay scenario where the relay UE is configured with multiple connections (i.e., the number of connections is equal or larger than two) to the RAN (e.g., dual connectivity, carrier aggregation etc.).

In the embodiments, the UE (e.g., remote UE) can connect to the same network node (e.g., gNB) via both a direct path and an indirect path (e.g., UE also connects to gNB via a relay UE).

In the following embodiments, for a Uu RB configured with PDCP duplication, corresponding RLC entities are established in both the direct path and the indirect path. As an example, it is assumed that the direct path is the primary path meanwhile the indirect path is the secondary path. Correspondingly, RLC entities on the primary path are the primary RLC entities, and RLC entities on the secondary path are the secondary RLC entities. However, the embodiments are not limited to this. The embodiments are equally applicable in case the indirect path is the primary path, while the direct path is the secondary path.

Upon activation of PDCP duplication for an Uu RB, UE needs to establish/setup RLC entities for the RB on the indirect path in addition to the direct path. These RLC entities may be referred to as secondary RLC entities including RLC entities on the PC5 hop and the Uu hop. PC5 RLC entities and Uu RLC entities are corresponding between each other. Meanwhile, RLC entities of the RB on the direct path may be referred to as primary RLC entities.

The methods and solution disclosed in the embodiments are described in the context of NR sidelink (SL) communications. However, most of the embodiments are in general applicable to any kind of direct communications between UEs involving device-to-device (D2D) communications such as LTE SL.

Embodiments are described from a remote UE and a relay UE point of view. Further, it is assumed that a SL UE and its serving network node such as gNB (if the UE is in NW coverage) operates with the same radio access technology (RAT), e.g., NR, LTE, and so on. However, all the embodiments apply without loss of meaning to any combination of RATs between the SL UE and its serving network node.

The link or radio link over which the signals are transmitted between at least two UEs for D2D operation is called herein as the sidelink (SL). The signals transmitted between the UEs for D2D operation are called herein as SL signals. The term SL may also interchangeably be called as D2D link, V2X link, prose link, peer-to-peer link, PC5 link etc. The SL signals may also interchangeably be called as V2X signals, D2D signals, prose signals, PC5 signals, peer-to-peer signals etc.

The embodiments are applicable to L2 relay scenarios. For example, the embodiments are applicable to the L2 based UE to NW (U2N) relay. The UE to NW relay UE is denoted as relay UE.

Further, the term “direct path” is used to describe a direct connection between the UE and the network that is operated over the Uu interface. Also, the term “indirect path” is used to describe a connection between the UE and the network via (or with the help of) a middle node that in the present disclosure is called “relay UE”. The UE is also called “remote UE” in these two terms without any loss of meaning.

As used herein, the term “Uu interface” may be referred to as the radio interface between a terminal device and a network node (such as base station, gNB, eNB, etc.). The term “PC5 interface” may be referred to as the radio interface between any two terminal devices.

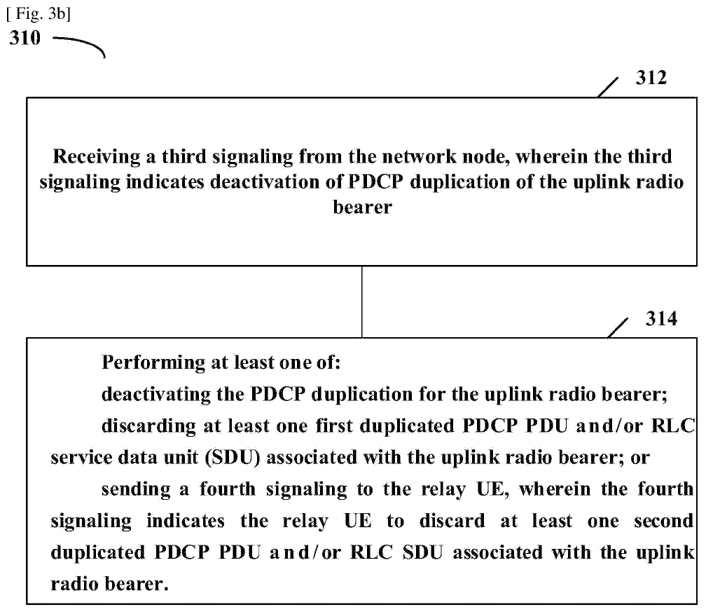

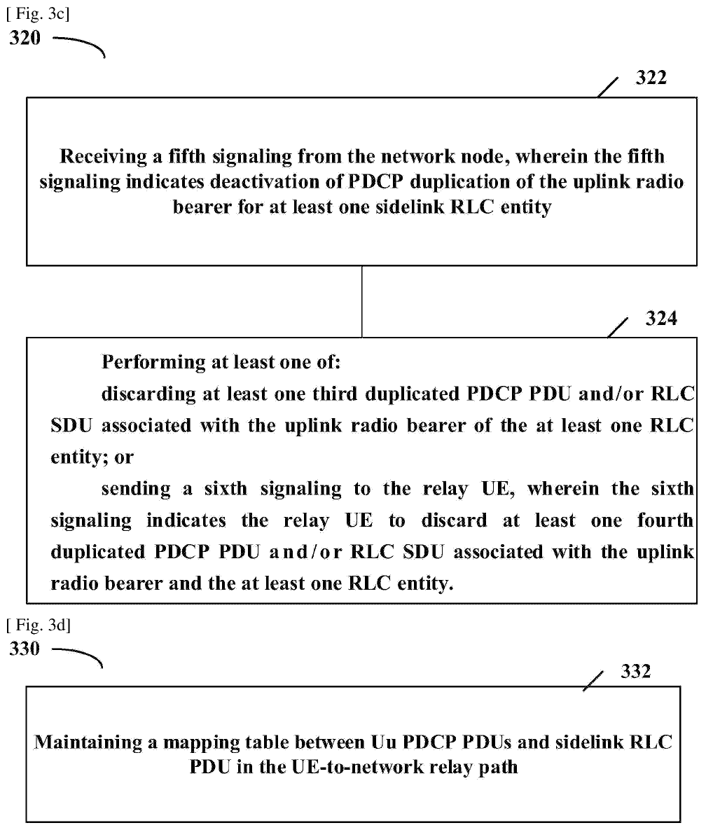

FIG. 3a shows a flowchart of a method according to an embodiment of the present disclosure, which may be performed by an apparatus implemented in or at or as a first user equipment (UE) or communicatively coupled to the first UE. As such, the apparatus may provide means or modules for accomplishing various parts of the method 300 as well as means or modules for accomplishing other processes in conjunction with other components.

In an embodiment, the first UE may be a remote UE in UE-to-Network Relay scenario.

In an embodiment, PDCP duplication for a RB is activated, the first UE has established/setup at least one PC5 RLC entity for the RB on an indirect path via a relay UE and at least one Uu RLC entity for the RB on a direct path.

In an embodiment, the at least one Uu RLC entity may be the primary RLC entity and the at least one PC5 RLC entity may be the secondary RLC entity.

In an embodiment, the at least one PC5 RLC entity may be the primary RLC entity and the at least one Uu RLC entity may be the secondary RLC entity.

At block 302, for an uplink radio bearer that has been activated with packet data convergence protocol (PDCP) duplication, the first UE may determine that a PDCP protocol data unit (PDU) has been successfully delivered to a network node via a relay UE on a UE-to-network relay path.

The first UE may determine that the PDCP PDU has been successfully delivered to the network node via the relay UE on the UE-to-network relay path in various ways. For example, the first UE may receive information indicating the PDCP PDU has been successfully delivered to the network node via the relay UE on the UE-to-network relay path from the relay UE or the network node. For example, the network node may send such information to the first UE on the UE-to-network relay path or UE-to-network direct path when it receives the PDCP PDU. The relay UE may send such information when it receives the PDCP PDU from the first UE or sends the PDCP PDU to the network node or receives such information from the network node. In addition, the first UE may determine that the PDCP PDU has been successfully delivered to the network node via the relay UE on the UE-to-network relay path based on any other suitable information from the relay UE or the network node.

In an embodiment, the first UE may receive a radio link control (RLC) status report from the relay UE. The RLC status report indicates that the PDCP PDU has been successfully transmitted to the relay UE in a sidelink. The first UE may determine that the PDCP PDU has been successfully delivered to the network node via the relay UE on the UE-to-network relay path based on the RLC status report. For example, this determination method may be used when the Uu link quality of the relay UE is good enough or greater than a threshold such that the relay UE can ensure that the PDCP PDU can be sent to the network node. Since this determination method is fast, the first UE can fast discard the duplicated PDCP PDU on the other path and save resources.

In an embodiment, the first UE may receive a PDCP status report from the network node. The PDCP status report indicates that the PDCP PDU has been successfully received by the network node via the UE-to-network relay path. The first UE may determine that the PDCP PDU has been successfully delivered to the network node on the UE-to-network relay path based on the PDCP status report. This determination method is accurate.

In an embodiment, the PDCP status report is received from the network node when at least one of an upper layer requests a PDCP entity re-establishment, an upper layer requests a PDCP data recovery, an upper layer requests a uplink data switching, an upper layer reconfigures a PDCP entity to release dual active protocol stack (DAPS) and daps-SourceRelease is configured in upper layer, an upper layer determines that a PDCP status report needs to be triggered, a periodic timer is expired, or PDCP duplication has been activated and at least one path for PDCP duplication is the UE-to-network relay path. The triggering conditions described above may be considered jointly or separately.

The following trigger conditions may be same as the corresponding trigger conditions as described in clause 5.4.1 of TS 38.323 v16.6.0: an upper layer requests a PDCP entity re-establishment, an upper layer requests a PDCP data recovery, an upper layer requests a uplink data switching, an upper layer reconfigures a PDCP entity to release dual active protocol stack (DAPS) and daps-SourceRelease is configured in upper layer.

The upper layer may determine that a PDCP status report needs to be triggered due to various reasons. For example, when it is necessary for PDCP receiving entity to provide a PDCP status report to PDCP transmitting entity, the upper layer may determine that a PDCP status report needs to be triggered due to various reasons. When the link quality of UE-to-network direct path is good enough or greater than a threshold, the upper layer may determine that a PDCP status report needs to be triggered. When the network node receives a request of PDCP status report from the first UE, the upper layer may determine that a PDCP status report needs to be triggered.

The periodic timer may be set as any suitable value. For example, the periodic timer may be set by an operator.

In an embodiment, when PDCP duplication has been activated while at least one path is the relay path, the network node may send the PDCP status report to the first UE.

In an embodiment, the upper layer may comprise a radio resource control (RRC) layer.

In an embodiment, the PDCP status report is received from the network node via a UE-to-network direct path and/or the UE-to-network relay path.

In an embodiment, the first UE may receive a first signaling from the relay UE. The first signaling indicates that the relay UE has received a RLC status report for the PDCP PDU from the network node. The RLC status report indicates that the PDCP PDU has been successfully transmitted to the network node in a Uu link. The first UE may determine that the PDCP PDU has been successfully delivered to the network node via the relay UE on the UE-to-network relay path based on the first signaling. For example, the first signaling may be RRC signaling (e.g., PC5-RRC) or MAC CE.

In an embodiment, the first UE may receive a second signaling from the network node via a UE-to-network direct path. The second signaling indicates that the PDCP PDU has been successfully received by the network node via the UE-to-network relay path. The first UE may determine that the PDCP PDU has been successfully delivered to the network node via the relay UE on the UE-to-network relay path based on the second signaling.

For example, the PDCP entity of the network node (such as gNB) may provide status report to the first UE via the direct path indicating successful reception of the PDCP PDU on the indirect path. The network node such as gNB may use other signaling options including RRC signaling, MAC CE, or L1 signaling (e.g., DCI on PDCCH) via the direct path indicating successful reception of the PDCP PDU on the indirect path.

In an embodiment, a method for determining that the PDCP PDU has been successfully delivered to the network node via the relay UE on the UE-to-network relay path may be configured by the network node, preconfigured in the UE and the relay UE, or hard-coded in a specification.

At block 304, the first UE may discard at least one duplicated PDCP PDU on at least one other UE-to-network path. By discarding operation, it can save resources.

In an embodiment, the at least one other UE-to-network path may comprise at least one of a UE-to-network relay path, or a UE-to-network direct path.

For example, there may be one UE-to-network relay path and one UE-to-network direct path. When the PDCP PDU has been successfully delivered to the network node via the relay UE on the UE-to-network relay path, the first UE may discard at least one duplicated PDCP PDU or RLC PDU on the UE-to-network direct path.

For example, there may be two UE-to-network relay paths. When the PDCP PDU has been successfully delivered to the network node via the relay UE on one UE-to-network relay path, the first UE may discard at least one duplicated PDCP PDU or RLC PDU on the other UE-to-network direct path.

For example, there may be two UE-to-network relay paths and one UE-to-network direct path. When the PDCP PDU has been successfully delivered to the network node via the relay UE on one UE-to-network relay path, the first UE may discard at least one duplicated PDCP PDU on the other UE-to-network direct path and the UE-to-network direct path.

As a first example, to discard at least one duplicated PDCP PDU on a UE-to-network relay path, the first UE may perform at least one of the following actions:
discard the associated PDCP PDU or PC5 RLC PDUs, or
send a signaling to the relay UE, the signaling indicates the associated PDCP PDU or PC5 RLC PDUs which need to be discarded. The signaling may be carried via a PC5-RRC signaling, a MAC CE or a control PDU of a protocol layer e.g., the sidelink adaptation layer (SRAP).

As a second example, to discard at least one duplicated PDCP PDU on a UE-to-network direct path, the first UE may discard the associated PDCP PDU or Uu RLC PDUs.

FIG. 3b shows a flowchart of a method according to another embodiment of the present disclosure, which may be performed by an apparatus implemented in or at or as a first user equipment (UE) or communicatively coupled to the first UE. As such, the apparatus may provide means or modules for accomplishing various parts of the method 310 as well as means or modules for accomplishing other processes in conjunction with other components. For some parts which have been described in the above embodiments, the description thereof is omitted here for brevity.

At block 312, the first UE may receive a third signaling from the network node. The third signaling indicates deactivation of PDCP duplication of the uplink radio bearer.

In an embodiment, the third signaling may be received from the network node via the UE-to-network relay path or the UE-to-network direct path.

In an embodiment, when the third signaling is received from the network node via the UE-to-network direct path, the third signaling may comprise at least one of RRC signaling, MAC CE, or L1 signaling (e.g., DCI on PDCCH).

At block 314, the first UE may perform at least one of deactivating the PDCP duplication for the uplink radio bearer; discarding at least one first duplicated PDCP PDU and/or RLC service data unit (SDU) associated with the uplink radio bearer; or sending a fourth signaling to the relay UE. The fourth signaling indicates the relay UE to discard at least one second duplicated PDCP PDU and/or RLC SDU associated with the uplink radio bearer.

The fourth signaling may comprise at least one of PC5 RRC signaling or MAC CE.

In an embodiment, the at least one second duplicated PDCP PDU and/or RLC SDU may comprise at least one of one or more PDCP PDUs and/or RLC SDUs associated with the uplink radio bearer that are received from the first UE and stored in at least one sidelink RLC entity, or one or more PDCP PDUs and/or RLC SDUs associated with the uplink radio bearer that are stored in at least one Uu RLC entity.

FIG. 3c shows a flowchart of a method according to another embodiment of the present disclosure, which may be performed by an apparatus implemented in or at or as a first user equipment (UE) or communicatively coupled to the first UE. As such, the apparatus may provide means or modules for accomplishing various parts of the method 320 as well as means or modules for accomplishing other processes in conjunction with other components. For some parts which have been described in the above embodiments, the description thereof is omitted here for brevity.

At block 322, the first UE may receive a fifth signaling from the network node. The fifth signaling indicates deactivation of PDCP duplication of the uplink radio bearer for at least one sidelink RLC entity.

In an embodiment, the fifth signaling may be received from the network node via the UE-to-network relay path or the UE-to-network direct path.

In an embodiment, when the fifth signaling is received from the network node via the UE-to-network direct path, the fifth signaling may comprise at least one of RRC signaling, MAC CE, or L1 signaling (e.g., DCI on PDCCH).

At block 324, the first UE may perform at least one of discarding at least one third duplicated PDCP PDU and/or RLC SDU associated with the uplink radio bearer of the at least one RLC entity or sending a sixth signaling to the relay UE. The sixth signaling indicates the relay UE to discard at least one fourth duplicated PDCP PDU and/or RLC SDU associated with the uplink radio bearer and the at least one RLC entity.

In an embodiment, the sixth signaling may comprise at least one of PC5 RRC signaling or MAC CE.

In an embodiment, the at least one fourth duplicated PDCP PDU and/or RLC SDU may comprise at least one of one or more PDCP PDUs and/or RLC SDUs associated with the uplink radio bearer that are received from the at least one RLC entity of the first UE and stored in one or more sidelink RLC entities of the relay UE, or one or more PDCP PDUs and/or RLC SDUs associated with the uplink radio bearer that are received from the at least one RLC entity of the first UE and stored in at least one Uu RLC entity of the relay UE.

FIG. 3d shows a flowchart of a method according to another embodiment of the present disclosure, which may be performed by an apparatus implemented in or at or as a first user equipment (UE) or communicatively coupled to the first UE. As such, the apparatus may provide means or modules for accomplishing various parts of the method 330 as well as means or modules for accomplishing other processes in conjunction with other components. For some parts which have been described in the above embodiments, the description thereof is omitted here for brevity.

At block 332, the first UE may maintain a mapping table between Uu PDCP PDUs and sidelink RLC PDU in the UE-to-network relay path.

In an embodiment, the mapping table may comprise at least one of a mapping of a Uu PDCP PDU to one or multiple PC5 RLC PDUs, or a mapping of one or multiple Uu PDCP PDUs to a PC5 RLC PDU.

In an embodiment, a Uu PDCP PDU is identified by a sequence number (SN) value of the Uu PDCP PDU and a sidelink RLC PDU is identified by a SN value of the sidelink RLC PDU in the mapping table.

In an embodiment, an entry corresponding to a Uu PDCP PDU is added into the mapping table when the Uu PDCP PDU is delivered to a sidelink RLC layer and the entry corresponding to the Uu PDCP PDU is deleted when the sidelink RLC layer indicates to a Uu PDCP layer that the Uu PDCP PDU has been successfully transmitted to a receiver or the Uu PDCP PDU has become invalid when a timer or a counter is expired.

For example, the mapping table may show at least one of the following
how a Uu PDCP PDU maps to one or multiple PC5 RLC PDUs, or
how one or multiple Uu PDCP PDUs map to a PC5 RLC PDU.

In an embodiment, sequence number (SN) values of Uu PDCP PDUs and PC5 RLC PDUs may be used as inputs in the mapping table.

In an embodiment, a new entry corresponding to a Uu PDCP PDU is added into the table when the Uu PDCP PDU is delivered to the PC5 RLC layer. The entry will be deleted when the PC5 RLC layer indicates to the Uu PDCP layer that the corresponding Uu PDCP PDU has been successfully transmitted to the receiver, meaning that either a corresponding PC5 RLC status report has been received from the receiver indicating a successful transmission or a timer or a counter is expired indicating that the Uu PDCP PDU has become invalid since the PC5 RLC layer has used up all retransmission opportunities for the associated PC5 RLC PDUs

Based on the mapping table, whenever a remote UE determines to discard a duplicate PDCP PDU or RLC PDU, the remote UE may perform at least one of the following actions:
discard the associated PDCP PDU or PC5 RLC PDUs, or
send a signaling to the relay UE, the signaling indicates the associated PDCP PDU or PC5 RLC PDUs which need to be discarded. The signaling may be carried via a PC5-RRC signaling, a MAC CE or a control PDU of a protocol layer e.g., the sidelink adaptation layer (SRAP).

In an embodiment, a signaling between a network node and the first UE may comprise at least one of a RRC signaling, medium access control (MAC) control element (CE), or a layer 1 signaling.

In an embodiment, a signaling between the relay UE and the first UE may comprise at least one of a RRC signaling, MAC CE, or a control PDU of a protocol layer. For example, e.g., the control PDU of a protocol layer may be the sidelink adaptation layer (SRAP).

FIG. 4a shows a flowchart of a method according to another embodiment of the present disclosure, which may be performed by an apparatus implemented in or at or as a relay UE or communicatively coupled to the relay UE. As such, the apparatus may provide means or modules for accomplishing various parts of the method 400 as well as means or modules for accomplishing other processes in conjunction with other components. For some parts which have been described in the above embodiments, the description thereof is omitted here for brevity.

At block 402, the relay UE may receive a PDCP PDU of an uplink radio bearer from a first UE. The uplink radio bearer has been activated with PDCP duplication.

In an embodiment, the PDCP PDU will be delivered to the network node via at least one of a UE-to-network relay path, or a UE-to-network direct path.

At block 404, the relay UE may send an indication that the PDCP PDU has been successfully delivered to a network node via the relay UE on a UE-to-network relay path to the first UE.

In an embodiment, the indication is a RLC status report indicating that the PDCP PDU has been successfully transmitted to the relay UE in a sidelink. For example, when the relay UE has successfully received the PDCP PDU from the first UE, the relay UE may send the RLC status report to the first UE.

In an embodiment, the indication indicates the relay UE has received a RLC status report for the PDCP PDU from the network node. For example, when the relay UE has received a RLC status report for the PDCP PDU from the network node, the relay UE may send the indication indicates the relay UE has received a RLC status report for the PDCP PDU from the network node to the first UE.

In an embodiment, which indication is used may be configured by the network node, preconfigured in the first UE and the relay UE, or hard-coded in a specification.

FIG. 4b shows a flowchart of a method according to another embodiment of the present disclosure, which may be performed by an apparatus implemented in or at or as a relay UE or communicatively coupled to the relay UE. As such, the apparatus may provide means or modules for accomplishing various parts of the method 410 as well as means or modules for accomplishing other processes in conjunction with other components. For some parts which have been described in the above embodiments, the description thereof is omitted here for brevity.

At block 412, the relay UE may receive a signaling from the first UE. The signaling indicates the relay UE to discard at least one second duplicated PDCP PDU and/or RLC SDU associated with the uplink radio bearer. The signaling may be PC5-RRC signaling, MAC CE or a control PDU of a protocol layer e.g., the sidelink adaptation layer (SRAP).

At block 414, the relay UE may discard at least one second duplicated PDCP PDU and/or RLC SDU associated with the uplink radio bearer.

In an embodiment, the at least one second duplicated PDCP PDU and/or RLC SDU may comprise at least one of one or more PDCP PDUs and/or RLC SDUs associated with the uplink radio bearer that are received from the first UE and stored in at least one sidelink RLC entity, or one or more PDCP PDUs and/or RLC SDUs associated with the uplink radio bearer that are stored in at least one Uu RLC entity.

FIG. 4c shows a flowchart of a method according to another embodiment of the present disclosure, which may be performed by an apparatus implemented in or at or as a relay UE or communicatively coupled to the relay UE. As such, the apparatus may provide means or modules for accomplishing various parts of the method 420 as well as means or modules for accomplishing other processes in conjunction with other components. For some parts which have been described in the above embodiments, the description thereof is omitted here for brevity.

At block 422, the relay UE may receive a signaling from the first UE. The signaling indicates the relay UE to discard at least one fourth duplicated PDCP PDU and/or RLC SDU associated with the uplink radio bearer and the at least one RLC entity. The signaling may be PC5-RRC signaling, MAC CE or a control PDU of a protocol layer e.g., the sidelink adaptation layer (SRAP).

At block 424, the relay UE may discard at least one fourth duplicated PDCP PDU and/or RLC SDU associated with the uplink radio bearer and the at least one RLC entity.

In an embodiment, the at least one fourth duplicated PDCP PDU and/or RLC SDU may comprise at least one of one or more PDCP PDUs and/or RLC SDUs associated with the uplink radio bearer that are received from the at least one RLC entity of the first UE and stored in one or more sidelink RLC entities, or one or more PDCP PDUs and/or RLC SDUs associated with the uplink radio bearer that are received from the at least one RLC entity of the first UE and stored in at least one Uu RLC entity.

FIG. 4d shows a flowchart of a method according to another embodiment of the present disclosure, which may be performed by an apparatus implemented in or at or as a relay UE or communicatively coupled to the relay UE. As such, the apparatus may provide means or modules for accomplishing various parts of the method 430 as well as means or modules for accomplishing other processes in conjunction with other components. For some parts which have been described in the above embodiments, the description thereof is omitted here for brevity.

At block 432, the relay UE may receive a signaling comprising an identifier of the first UE from the network node. The signaling indicates discarding duplicated PDCP PDUs and/or RLC SDUs associated with the uplink radio bearer. The identifier of the first UE may be used by the relay UE to know to which the uplink radio bearer belong to.

At block 434, the relay UE may discard duplicated PDCP PDUs and/or RLC SDUs associated with the uplink radio bearer.

FIG. 4e shows a flowchart of a method according to another embodiment of the present disclosure, which may be performed by an apparatus implemented in or at or as a relay UE or communicatively coupled to the relay UE. As such, the apparatus may provide means or modules for accomplishing various parts of the method 440 as well as means or modules for accomplishing other processes in conjunction with other components. For some parts which have been described in the above embodiments, the description thereof is omitted here for brevity.

At block 442, the relay UE may receive a signaling comprising an identifier of the first UE from the network node. The signaling indicates deactivating at least one RLC entity of the uplink radio bearer in the UE-to-network relay path.

At block 444, the relay UE may deactivate at least one RLC entity of the uplink radio bearer in the UE-to-network relay path.

FIG. 4f shows a flowchart of a method according to another embodiment of the present disclosure, which may be performed by an apparatus implemented in or at or as a relay UE or communicatively coupled to the relay UE. As such, the apparatus may provide means or modules for accomplishing various parts of the method 450 as well as means or modules for accomplishing other processes in conjunction with other components. For some parts which have been described in the above embodiments, the description thereof is omitted here for brevity.

At block 452, the relay UE may maintain a mapping table between Uu PDCP PDUs and sidelink RLC PDU in the UE-to-network relay path.

In an embodiment, the mapping table may comprise at least one of a mapping of a PC5 RLC PDU to one or multiple Uu PDCP PDUs, or a mapping of one or multiple PC5 RLC PDUs to a Uu PDCP PDU.

In an embodiment, a Uu PDCP PDU is identified by a sequence number (SN) value of the Uu PDCP PDU and a sidelink RLC PDU is identified by a SN value of the sidelink RLC PDU, an identifier of the uplink radio bearer and an identifier of the first UE in the mapping table.

In an embodiment, a signaling between a network node and the relay UE may comprise at least one of a RRC signaling, medium access control (MAC) control element (CE), or a layer 1 signaling.

In an embodiment, a signaling between the relay UE and the first UE may comprise at least one of a RRC signaling, MAC CE, or a control PDU of a protocol layer.

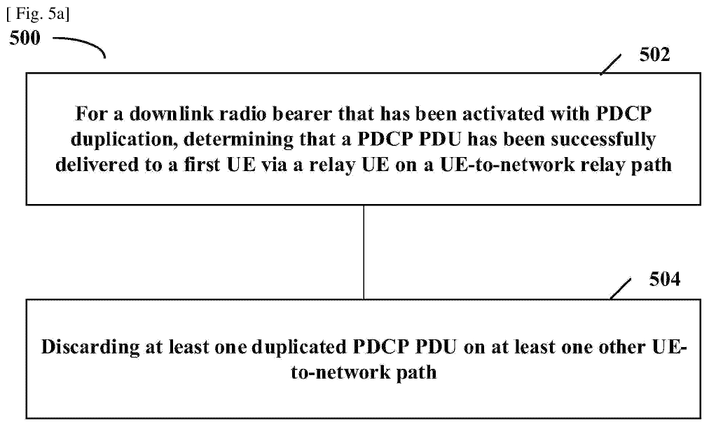

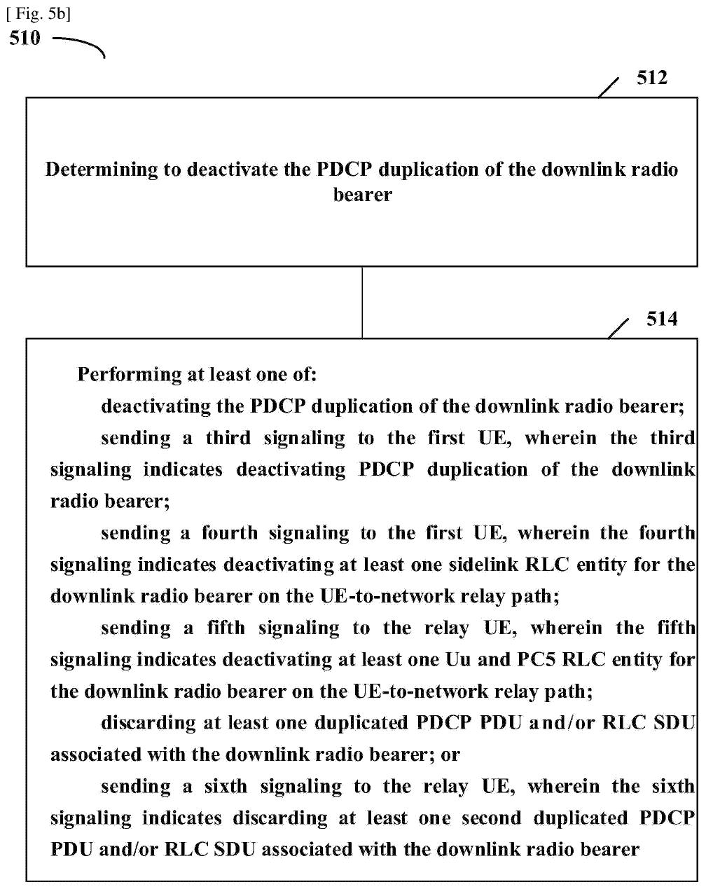

FIG. 5a shows a flowchart of a method according to another embodiment of the present disclosure, which may be performed by an apparatus implemented in or at or as a network node or communicatively coupled to the network node. As such, the apparatus may provide means or modules for accomplishing various parts of the method 500 as well as means or modules for accomplishing other processes in conjunction with other components. For some parts which have been described in the above embodiments, the description thereof is omitted here for brevity.

At block 502, for a downlink radio bearer that has been activated with PDCP duplication, the network node may determine that a PDCP PDU has been successfully delivered to a first UE via a relay UE on a UE-to-network relay path.

The network node may determine that the PDCP PDU has been successfully delivered to the first UE via the relay UE on the UE-to-network relay path in various ways. For example, the network node may receive information indicating the PDCP PDU has been successfully delivered to the first UE via the relay UE on the UE-to-network relay path from the relay UE or the first UE. For example, the first UE may send such information to the network node on the UE-to-network relay path or UE-to-network direct path when it receives the PDCP PDU. The relay UE may send such information to the network node when it receives the PDCP PDU from the network node or sends the PDCP PDU to the first UE or receives such information from the first UE. In addition, the network node may determine that the PDCP PDU has been successfully delivered to the first UE via the relay UE on the UE-to-network relay path based on any other suitable information from the relay UE or the first UE.

In an embodiment, the network node may receive a RLC status report from the relay UE. The RLC status report indicates that the PDCP PDU has been successfully transmitted to the relay UE in a Uu link. The network node may determine that the PDCP PDU has been successfully delivered to the first UE via the relay UE on the UE-to-network relay path based on the RLC status report.

In an embodiment, the network node may receive a PDCP status report from the first UE. The PDCP status report indicates that the PDCP PDU has been successfully received by the first UE via the UE-to-network relay path. The network node may determine that the PDCP PDU has been successfully delivered to the first UE on the UE-to-network relay path based on the PDCP status report.

In an embodiment, the PDCP status report is received by the network node when at least one of an upper layer requests a PDCP entity re-establishment, an upper layer requests a PDCP data recovery, an upper layer requests a downlink data switching, an upper layer reconfigures a PDCP entity to release dual active protocol stack (DAPS) and daps-SourceRelease is configured in upper layer, an upper layer determines that a PDCP status report needs to be triggered, a periodic timer is expired, or PDCP duplication has been activated and at least one path for PDCP duplication is the UE-to-network relay path. The triggering conditions described above may be considered jointly or separately.

In an embodiment, the upper layer may comprise a radio resource control (RRC) layer.

In an embodiment, the network node may the PDCP status report is received by the network node via a direct path and/or the UE-to-network relay path.

In an embodiment, the network node may receive a first signaling from the relay UE. The first signaling indicates that the relay UE has received a RLC status report for the PDCP PDU from the first UE. The RLC status report indicates that the PDCP PDU has been successfully transmitted to the first UE in a sidelink. The network node may determine that the PDCP PDU has been successfully delivered to the first UE via the relay UE on the UE-to-network relay path based on the first signaling.

In an embodiment, the network node may receive a second signaling from the first UE via a UE-to-network direct path. The second signaling indicates that the PDCP PDU has been successfully received by the first UE via the UE-to-network relay path. The network node may determine that the PDCP PDU has been successfully delivered to the first UE via the relay UE on the UE-to-network relay path based on the second signaling.

In an embodiment, a method for determining that the PDCP PDU has been successfully delivered to the first UE via the relay UE on the UE-to-network relay path is configured by a core network entity, or hard-coded in a specification.

At block 504, the network node may discard at least one duplicated PDCP PDU on at least one other UE-to-network path.

In an embodiment, the at least one other UE-to-network path may comprise at least one of a UE-to-network relay path, or a UE-to-network direct path.

For example, there may be one UE-to-network relay path and one UE-to-network direct path. When the PDCP PDU has been successfully delivered to the network node via the relay UE on the UE-to-network relay path, the first UE may discard at least one duplicated PDCP PDU on the UE-to-network direct path.

For example, there may be two UE-to-network relay paths. When the PDCP PDU has been successfully delivered to the first UE via the relay UE on one UE-to-network relay path, the network node may discard at least one duplicated PDCP PDU on the other UE-to-network direct path.

For example, there may be two UE-to-network relay paths and one UE-to-network direct path. When the PDCP PDU has been successfully delivered to the first UE via the relay UE on one UE-to-network relay path, the network node may discard at least one duplicated PDCP PDU on the other UE-to-network direct path and the UE-to-network direct path.

As a first example, to discard at least one duplicated PDCP PDU on a UE-to-network relay path, the network node may perform at least one of the following actions:
discard the associated RLC PDUs, or
send a signaling to the relay UE, the signaling indicates the associated PC5 RLC PDUs which need to be discarded. The signaling may be carried via a RRC signaling, a MAC CE or L1 signaling.

As a second example, when the network node discards at least one duplicated PDCP PDU on a UE-to-network direct path, the first UE may discard the associated Uu RLC PDUs.

FIG. 5b shows a flowchart of a method according to another embodiment of the present disclosure, which may be performed by an apparatus implemented in or at or as a network node or communicatively coupled to the network node. As such, the apparatus may provide means or modules for accomplishing various parts of the method 510 as well as means or modules for accomplishing other processes in conjunction with other components. For some parts which have been described in the above embodiments, the description thereof is omitted here for brevity.

At block 512, the network node may determine to deactivate the PDCP duplication of the downlink radio bearer.

At block 514, the network node may perform at least one of deactivating the PDCP duplication of the downlink radio bearer; sending a third signaling to the first UE; sending a fourth signaling to the first UE; sending a fifth signaling to the relay UE; discarding at least one duplicated PDCP PDU and/or RLC SDU associated with the downlink radio bearer; or sending a sixth signaling to the relay UE. The sixth signaling indicates discarding at least one second duplicated PDCP PDU and/or RLC SDU associated with the downlink radio bearer. The third signaling indicates deactivating PDCP duplication of the downlink radio bearer. The fourth signaling indicates deactivating at least one sidelink RLC entity for the downlink radio bearer on the UE-to-network relay path. The fifth signaling indicates deactivating at least one Uu and PC5 RLC entity for the downlink radio bearer on the UE-to-network relay path.

In an embodiment, the at least one second duplicated PDCP PDU and/or RLC SDU may comprise at least one of one or more PDCP PDUs and/or RLC SDUs associated with the uplink radio bearer that are received from the network node and stored in at least one Uu RLC entity of the relay UE, or one or more PDCP PDUs and/or RLC SDUs associated with the uplink radio bearer that are stored in at least one sidelink RLC entity of the relay UE.

FIG. 6 shows a flowchart of a method according to another embodiment of the present disclosure, which may be performed by an apparatus implemented in or at or as a network node or communicatively coupled to the network node. As such, the apparatus may provide means or modules for accomplishing various parts of the method 600 as well as means or modules for accomplishing other processes in conjunction with other components. For some parts which have been described in the above embodiments, the description thereof is omitted here for brevity.

At block 602, the network node may maintain a mapping table between Uu PDCP PDUs and Uu RLC PDU in the UE-to-network relay path.

In an embodiment, the mapping table may comprise at least one of a mapping of a Uu PDCP PDU to one or multiple Uu RLC PDUs, or a mapping of one or multiple Uu PDCP PDUs to a Uu RLC PDU.

In an embodiment, a Uu PDCP PDU is identified by a sequence number (SN) value of the Uu PDCP PDU and a Uu RLC PDU is identified by a sequence number (SN) value of the Uu RLC PDU in the mapping table.

In an embodiment, an entry corresponding to a Uu PDCP PDU is added into the mapping table when the Uu PDCP PDU is delivered to a Uu RLC layer and the entry corresponding to the Uu PDCP PDU is deleted when the Uu RLC layer indicates to a Uu PDCP layer that the Uu PDCP PDU has been successfully transmitted to a receiver or the Uu PDCP PDU has become invalid when a timer or a counter is expired.

In an embodiment, a signaling between a network node and the first UE may comprise at least one of a RRC signaling, medium access control (MAC) control element (CE), or a layer 1 signaling.

In an embodiment, a signaling between the relay UE and the first UE may comprise at least one of a RRC signaling, MAC CE, or a control PDU of a protocol layer.

Based on the mapping table, whenever the network node determines to discard a duplicate PDCP PDU of a RB belonging to a certain remote UE, the network node may perform at least one of the following actions:
discards the associated Uu RLC PDUs which are not yet transmitted, or
sends a signaling to the relay UE. The signaling indicates the associated Uu RLC PDUs which need to be discarded. The signaling may be carried via a Uu-RRC signaling, a MAC CE or a control PDU of a protocol layer e.g., the sidelink adaptation layer (SRAP).

In the following, Group A embodiments and Group B embodiments are described.

### Group A Embodiments-Handling PDCP Duplication for a UL RB

For a UL radio bearer (RB) that has been activated with PDCP duplication, whenever a remote UE (e.g., UE1) has successfully transmitted a PDCP PDU on one path of multiple paths (such as UE-to-network relay path and UE-to-network direct path), the remote UE may discard the duplicated PDCP PDU on the other path(s).

For the A-1 embodiment, for a UL radio bearer (RB), the remote UE determines whether a PDCP PDU has been successfully delivered to a network node such as gNB on the indirect path using one of the following options

Option 1: one of the associated PC5 transmitting RLC entities has received corresponding RLC status reports from the relay UE (e.g., relay UE) indicating that the PDCP PDU has been successfully transmitted in the PC5 hop.

Option 2: the PDCP entity (e.g., transmitting entity) of the remote UE has received corresponding PDCP status reports from the network node such as gNB indicating that the PDCP PDU has been successfully received by the network node such as gNB via the indirect path. In order to enable a PDCP entity (e.g., receiving entity) to provide a status report to a PDCP transmitting entity, in addition to the following existing trigger conditions for PDCP status report (as captured in clause 5.4.1 of TS 38.323 v16.6.0), at least one new condition may be configured to PDCP receiving entity (e.g., the network node such as gNB in this case):
upper layer requests a PDCP entity re-establishment;
upper layer requests a PDCP data recovery;
upper layer requests a uplink data switching; or
upper layer reconfigures the PDCP entity to release DAPS and daps-SourceRelease is configured in upper layer (i.e., RRC).

In an embodiment, at least one of the following new conditions are configured to PDCP receiving entity:
Upper layer (i.e., RRC) determines that a PDCP status report needs to be triggered, e.g., it is necessary for PDCP receiving entity to provide a PDCP status report to PDCP transmitting entity,
A periodic timer is expired, or
PDCP duplication has been activated while at least one path is the relay path.

Option 3: the relay UE has sent a signaling to the remote UE indicating that the relay UE has received corresponding RLC status reports for the PDCP PDU from the network node such as gNB indicating that the PDCP PDU has been successfully transmitted in the Uu hop. The signaling may be carried via one of the following:
RRC signaling (e.g., PC5-RRC), or
MAC CE.

Option 4: the network node such as gNB provides a signaling via the direct path to the remote UE to acknowledge reception of the PDCP PDU on the indirect path.

For this option, the PDCP entity of the network node may provide a status report to remote UE via the direct path indicating successful reception of the PDCP PDU on the indirect path.

For this option, the network node such as gNB may use other signaling options including RRC signaling, MAC CE, or L1 signaling (e.g., DCI on PDCCH) via the direct path to indicate successful reception of the PDCP PDU on the indirect path.

Which option should be applied by remote UE and relay UE can be configured by the network node such as gNB or captured in specification in a hard coded fashion.

For the A-2 embodiment, for a UL radio bearer (RB), upon reception of a signaling from the network node such as gNB indicating deactivation of PDCP duplication of the RB, remote UE performs at least one of the following corresponding actions:
deactivate the PDCP duplication for the RB;
instructs remote UE's PC5 RLC entities associated with the RB to discard all duplicated PDCP PDUs/RLC SDUS;
sends signaling (e.g., PC5 RRC signaling or MAC CE) to relay UE indicating that relay UE should discard all duplicate PDCP PDUs/RLC SDUs associated with the RB, which are received from remote UE, including:
the ones received in the PC5 hop and stored in all the PC5 RLC entities associated with the RB, ⋅the ones stored in the Uu RLC entities of the Uu hop which are associated with the RB.

For the A-3 embodiment, for a UL radio bearer (RB), upon reception of a signaling from the network node such as gNB indicating deactivation of PDCP duplication for at least one associated RLC entity (e.g., PC5 RLC entities), remote UE performs at least one of the following corresponding actions:
instructs remote UE's PC5 RLC entities which are indicated in the signaling to discard all duplicated PDCP PDUs/RLC SDUs;
sends signaling (e.g., PC5 RRC signaling or MAC CE) to relay UE indicating that relay UE should discard all duplicate PDCP PDUs/RLC SDUs associated with the RB, which are received from remote UE, including:
the ones received in the PC5 hop and stored in the PC5 RLC entities which are indicated in the signaling, or
the ones stored in the Uu RLC entities of the Uu hop which are associated with the RB and received from the indicated PC5 RLC entities.

In addition, relay UE and remote UE may receive from the network node such as gNB a signaling of deactivating RLC entities of the RB in the indirect path.

In addition, relay UE may receive from the network node such as gNB a signaling of discarding duplicate PDCP PDUs and/or RLC SDUs associated with the RB. In case there are multiple remote UEs served by relay UE, the signaling should also indicate the ID of remote UE to which the RB belongs.

For the A-4 embodiment, for a UL radio bearer (RB) with PDCP duplication being activated, remote UE maintains a mapping table between Uu PDCP PDUs and PC5 RLC PDUs in the indirect path. In other words, the mapping table shows at least one of the following:
how a Uu PDCP PDU maps to one or multiple PC5 RLC PDUs, or
how one or multiple Uu PDCP PDUs map to a PC5 RLC PDU.

Sequence number (SN) values of Uu PDCP PDUs and PC5 RLC PDUs are used as inputs in the mapping table.

A new entry corresponding to a Uu PDCP PDU is added into the table when the Uu PDCP PDU is delivered to the PC5 RLC layer. The entry will be deleted when the PC5 RLC layer indicates to the Uu PDCP layer that the corresponding Uu PDCP PDU has been successfully transmitted to the receiver, meaning that:
either a corresponding PC5 RLC status report has been received from the receiver indicating a successful transmission, or
a timer or a counter is expired indicating that the Uu PDCP PDU has become invalid since the PC5 RLC layer has used up all retransmission opportunities for the associated PC5 RLC PDUs.

Based on the mapping table, whenever remote UE determines to discard a duplicate PDCP PDU, remote UE may perform at least one of the following actions:
discard the associated PC5 RLC PDUs.
send to relay UE a signaling indicating that the associated PC5 RLC PDUs need to be discarded. The signaling may be carried via a PC5-RRC signaling, a MAC CE or a control PDU of a protocol layer e.g., the sidelink adaptation layer (SRAP).

For the A-5 embodiment, for a UL radio bearer, relay UE maintains a mapping table between PC5 RLC PDUs and Uu RLC PDUs. In other words, the mapping table shows at least one of the following:
how a PC5 RLC PDU maps to one or multiple Uu RLC PDUs, or
how one or multiple PC5 RLC PDUs map to a Uu RLC PDU.

In the mapping table, remote UE's ID, RB ID and SNs of PC5 RLC PDUs are used as identifiers for PC5 RLC PDUs since there may be multiple remote UEs connecting to the relay UE at the same time. In addition, SNs of Uu RLC PDUs are also used as inputs in the mapping table to represent Uu RLC PDUs.

Based on the mapping table, whenever relay UE has received from remote UE a signaling of discarding one or multiple PC5 RLC PDUs, relay UE finds the corresponding Uu RLC PDUs. Relay UE can further discard these indicated PC5 RLC PDUs and/or Uu RLC PDUs.

Relay UE may also have some Uu RLC SDUs in the queue and waiting to be transmitted over the Uu hop. For these Uu RLC SDUs, in case relay UE has received from remote UE a signaling of discarding one or multiple PC5 RLC PDUs, relay UE can find corresponding Uu RLC SDUs and discard them.

### Group B Embodiments—Handling PDCP Duplication for a DL RB

For a DL radio bearer (RB) that has been activated with PDCP duplication, whenever the network node such as gNB has successfully transmitted a PDCP PDP on one path of multiple paths (such as UE-to-network relay path and UE-to-network direct path), the network node such as gNB may discard the duplicated PDCP PDU on the other path(s).

For the B-1 embodiment, for a DL radio bearer (RB), the network node such as gNB determines whether a PDCP PDU has been successfully delivered to remote UE on the indirect path using one of the following options:

Option 1: one of the associated Uu transmitting RLC entities has received corresponding RLC status reports from relay UE indicating that the PDCP PDU has been successfully transmitted in the Uu hop.

Option 2: the PDCP entity (e.g., transmitting entity) of the network node such as gNB has received corresponding PDCP status reports from remote UE. In order to enable a PDCP entity (e.g., receiving entity) to provide a status report to a PDCP transmitting entity, in addition to the following existing trigger conditions for PDCP status report (as captured in clause 5.4.1 of TS 38.323 v16.6.0), at least one new condition may be configured to PDCP receiving entity (e.g., the remote UE in this case): upper layer requests a PDCP entity re-establishment;
upper layer requests a PDCP data recovery;
upper layer requests a uplink data switching;
upper layer reconfigures the PDCP entity to release DAPS and daps-SourceRelease is configured in upper layer (i.e., RRC).

In an embodiment, at least one of the following new conditions are configured to PDCP receiving entity:
Upper layer (i.e., RRC) determines that a PDCP status report needs to be triggered, e.g., it is necessary for PDCP receiving entity to provide a PDCP status report to PDCP transmitting entity,
A periodic timer is expired, or
PDCP duplication has been activated while at least one path is the relay path.

Option 3: relay UE has sent to the network node such as gNB a signaling indicating that relay UE has received corresponding RLC status reports for the PDCP PDU from remote UE, which indicates that the PDCP PDU has been successfully transmitted in the PC5 hop. The signaling may be carried via one of the following:
RRC signaling, or
MAC CE.

Option 4: remote UE provides a signaling via the direct path to the network node such as gNB. The signaling acknowledges reception of the PDCP PDU on the indirect path.

For this option, remote UE's PDCP entity may provide status report to the network node such as gNB via the direct path. The status report indicates successful reception of the PDCP PDU on the indirect path.

For this option, remote UE may use other signaling options including RRC signaling, MAC CE, or L1 signaling (e.g., UCI on PUCCH) via the direct path to indicate successful reception of the PDCP PDU on the indirect path.

Which option should be applied by the network node such as gNB can be configured by the core network entity or captured in specs in a hard coded fashion or up to implementation of network node such as gNB.

For the B-2 embodiment, for a DL radio bearer (RB), the network node such as gNB may determine to deactivate PDCP duplication for the RB. The network node such as gNB performs at least one of the following corresponding actions to the deactivation of PDCP duplication of the RB:
deactivates the PDCP duplication for the RB;
sends signaling to remote UE of deactivating PDCP duplication for the RB;
sends signaling to remote UE of deactivating PC5 RLC entities on the indirect path;
sends signaling to relay UE of deactivating Uu and PC5 RLC entities on the indirect path;
instructs the Uu RLC entities associated with the RB of the network node such as gNB to discard all duplicated PDCP PDUs/RLC SDUs;
sends signaling (e.g., Uu RRC signaling or MAC CE) to relay UE to indicate that relay UE should discard all duplicate PDCP PDUs/RLC SDUs associated with the RB of remote UE, which are received from the network node such as gNB, including:
the ones received in the Uu hop and stored in all the Uu RLC entities associated with the RB of remote UE, and
the ones stored in the PC5 RLC entities of the PC5 hop which are associated with the RB of remote UE

For the B-3 embodiment, for a DL radio bearer (RB), upon reception of a signaling from the network node such as gNB indicating deactivation of PDCP duplication for at least one RLC entities (e.g., PC5 RLC entities) associated to the DL RB, remote UE performs at least one of the following corresponding actions:
instruct remote UE's PC5 RLC entities which are indicated in the signalling to discard all duplicated PDCP PDUs/RLC SDUs from the associated DL RB;
sends signaling (e.g., PC5 RRC signaling or MAC CE) to relay UE indicating that relay UE should discard all duplicated PDCP PDUs/RLC SDUs received from the indicated DL RB and associated with the indicated RLC entities, which are received from the gNB, including:
the ones received in the Uu hop and stored in the Uu RLC entities which are indicated in the signaling, and
the ones stored in the PC5 RLC entities indicated in the signaling.

For the B-4 embodiment, for a DL radio bearer (RB) with PDCP duplication being activated, the network node such as gNB maintains a mapping table between Uu PDCP PDUs and Uu RLC PDUs in the indirect path. In other words, the mapping table shows at least one of the following:
how a Uu PDCP PDU maps to one or multiple Uu RLC PDUs
how one or multiple Uu PDCP PDUs map to a Uu RLC PDU
SNs of Uu PDCP PDUs and Uu RLC PDUs are used as inputs in the mapping table.

A new entry corresponding to a Uu PDCP PDU is added into the table when the Uu PDCP PDU is delivered to the Uu RLC layer. The entry will be deleted when the Uu RLC layer indicates to the Uu PDCP layer that the corresponding Uu PDCP PDU has been successfully transmitted to the receiver, meaning that:
either a corresponding Uu RLC status report has been received from the receiver indicating a successful transmission, or
a timer or a counter is expired indicating that the Uu PDCP PDU has become invalid since the Uu RLC layer has used up all retransmission opportunities for the associated PC5 RLC PDUs.

Based on the mapping table, whenever the network node such as gNB determines to discard a duplicate PDCP PDU of a RB belonging to a certain remote UE (e.g. remote UE), the network node such as gNB may perform at least one of the following actions:
discards the associated Uu RLC PDUs which are not yet transmitted.
sends a signaling to relay UE of the associated Uu RLC PDUs which need to be discarded. The signaling may be carried via a Uu-RRC signaling, a MAC CE or a control PDU of a protocol layer e.g., the sidelink adaptation layer (SRAP).

For the B-5 embodiment, for a DL radio bearer, relay UE maintains a mapping table between Uu RLC PDUs and PC5 RLC PDUs. In other words, the mapping table shows at least one of the following:
how a Uu RLC PDU maps to one or multiple PC5 RLC PDUs, and
how one or multiple Uu RLC PDUs map to a PC5 RLC PDU

In the mapping table, remote UE's ID, RB ID and SNs of Uu RLC PDUs are used as identifiers for Uu RLC PDUs since there may be multiple remote UEs connecting to relay UE as a relay UE at the same time. In addition, SNs of PC5 RLC PDUs are also used as inputs in the mapping table to represent PC5 RLC PDUs.

Based on the mapping table, whenever relay UE has received from the network node such as gNB a signaling of discarding one or multiple Uu RLC PDUs, the relay UE finds the corresponding PC5 RLC PDUs. The relay UE can further discard these indicated Uu RLC PDUs and/or PC5 RLC PDUs.

For a UE which connects to the same network node such as gNB via both a direct path and indirect path, various embodiments cover how to remove duplicate PDU in the indirect path in cases including:
1) if the successful delivery of a PDCP data PDU is confirmed by one of the associated AM RLC entities,
2) if the deactivation of PDCP duplication is indicated for the DRB, or
3) if the deactivation of PDCP duplication is indicated for at least one associated RLC entities.

The embodiments cover both UL (uplink) cases and DL (downlink) cases respectively.

Embodiments herein may provide many advantages, of which a non-exhaustive list of examples follows. In some embodiments herein, it can avoid redundant duplicate PDUs to be transmitted. In some embodiments herein, it can ensure PDCP duplication to work properly in Uu and SL mixed multi-path scenarios. The embodiments herein are not limited to the features and advantages mentioned above. A person skilled in the art will recognize additional features and advantages upon reading the following detailed description.

FIG. 7 is a block diagram showing an apparatus suitable for practicing some embodiments of the disclosure. For example, any one of the first UE, the relay UE and the network node described above may be implemented as or through the apparatus 700.

The apparatus 700 comprises at least one processor 721, such as a digital processor (DP), and at least one memory (MEM) 722 coupled to the processor 721. The apparatus 700 may further comprise a transmitter TX and receiver RX 723 coupled to the processor 721. The MEM 722 stores a program (PROG) 724. The PROG 724 may include instructions that, when executed on the associated processor 721, enable the apparatus 700 to operate in accordance with the embodiments of the present disclosure. A combination of the at least one processor 721 and the at least one MEM 722 may form processing means 725 adapted to implement various embodiments of the present disclosure.

Various embodiments of the present disclosure may be implemented by computer program executable by one or more of the processor 721, software, firmware, hardware or in a combination thereof.

The MEM 722 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 721 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the first UE, the memory 722 contains instructions executable by the processor 721, whereby the first UE operates according to any of the methods related to the first UE as described above.

In an embodiment where the apparatus is implemented as or at the relay UE, the memory 722 contains instructions executable by the processor 721, whereby the relay UE operates according to any of the methods related to the relay UE as described above.

In an embodiment where the apparatus is implemented as or at the network node, the memory 722 contains instructions executable by the processor 721, whereby the network node operates according to any of the methods related to the network node as described above.

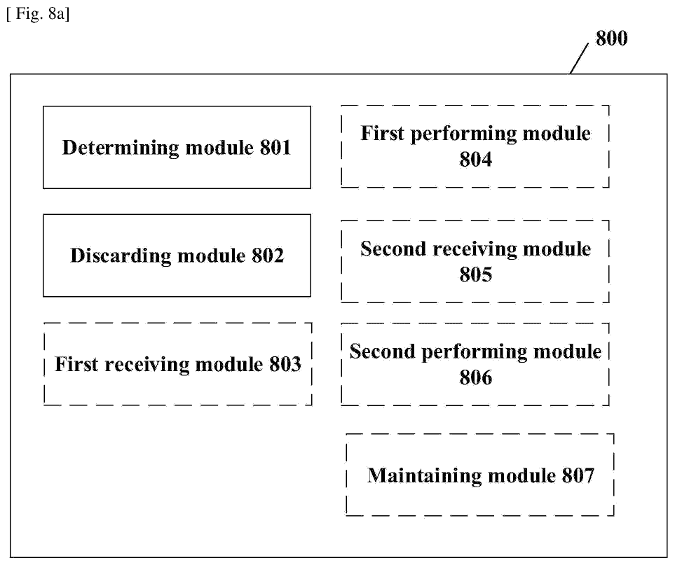

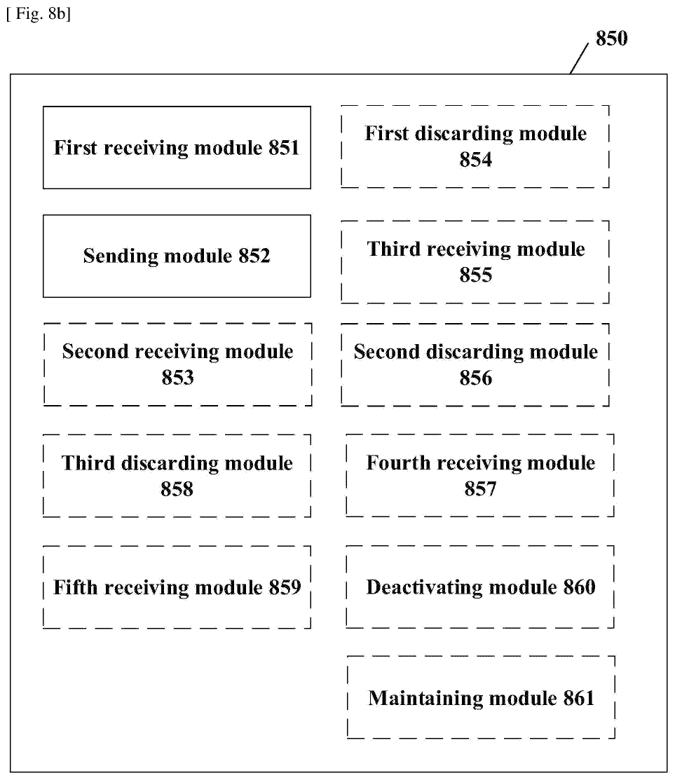

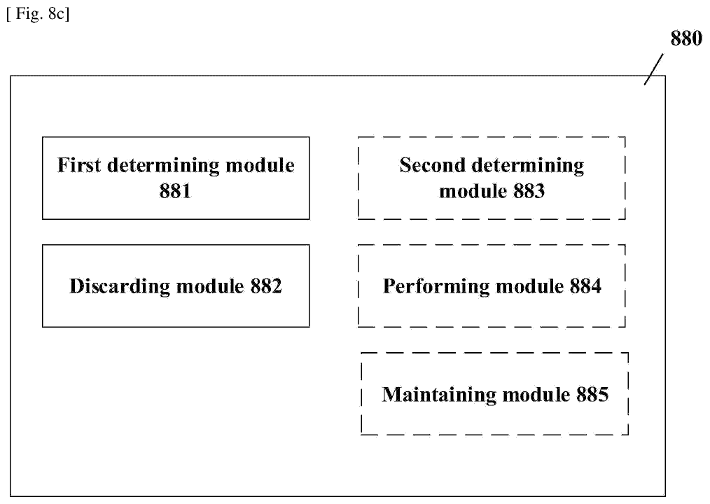

FIG. 8a is a block diagram showing a first UE according to an embodiment of the disclosure. As shown, the first UE 800 comprises a determining module 801 configured to, for an uplink radio bearer that has been activated with packet data convergence protocol (PDCP) duplication, determine that a PDCP protocol data unit (PDU) has been successfully delivered to a network node via a relay UE on a UE-to-network relay path. The first UE 800 may further comprise a discarding module 802 configured to discard at least one duplicated PDCP PDU on at least one other UE-to-network path.

In an embodiment, the first UE 800 may further comprise a first receiving module 803 configured to receive a third signaling from the network node. The third signaling indicates deactivation of PDCP duplication of the uplink radio bearer.

In an embodiment, the first UE 800 may further comprise a first performing module 804 configured to perform at least one of: deactivating the PDCP duplication for the uplink radio bearer; discarding at least one first duplicated PDCP PDU and/or RLC service data unit (SDU) associated with the uplink radio bearer; or sending a fourth signaling to the relay UE. The fourth signaling indicates the relay UE to discard at least one second duplicated PDCP PDU and/or RLC SDU associated with the uplink radio bearer.

In an embodiment, the first UE 800 may further comprise a second receiving module 805 configured to receive a fifth signaling from the network node. The fifth signaling indicates deactivation of PDCP duplication of the uplink radio bearer for at least one sidelink RLC entity.

In an embodiment, the first UE 800 may further comprise a second performing module 806 configured to perform at least one of: discarding at least one third duplicated PDCP PDU and/or RLC SDU associated with the uplink radio bearer of the at least one RLC entity; or sending a sixth signaling to the relay UE. The sixth signaling indicates the relay UE to discard at least one fourth duplicated PDCP PDU and/or RLC SDU associated with the uplink radio bearer and the at least one RLC entity.

In an embodiment, the first UE 800 may further comprise a maintaining module 807 configured to maintain a mapping table between Uu PDCP PDUs and sidelink RLC PDU in the UE-to-network relay path.

FIG. 8b is a block diagram showing a relay UE 850 according to an embodiment of the disclosure. As shown, the relay UE 850 comprises a first receiving module 851 configured to receive a PDCP PDU of an uplink radio bearer from a first UE. The uplink radio bearer has been activated with PDCP duplication. The relay UE 850 comprises a sending module 852 configured to send an indication that the PDCP PDU has been successfully delivered to a network node via the relay UE on a UE-to-network relay path to the first UE.

In an embodiment, the relay UE 850 may further comprise a second receiving module 853 configured to receive a signaling from the first UE. The signaling indicates the relay UE to discard at least one second duplicated PDCP PDU and/or RLC SDU associated with the uplink radio bearer. The relay UE 850 may further comprise a first discarding module 854 configured to discard at least one second duplicated PDCP PDU and/or RLC SDU associated with the uplink radio bearer.

In an embodiment, the relay UE 850 may further comprise a third receiving module 855 configured to receive a signaling from the first UE. The signaling indicates the relay UE to discard at least one fourth duplicated PDCP PDU and/or RLC SDU associated with the uplink radio bearer and the at least one RLC entity. The relay UE 850 may further comprise a second discarding module 856 configured to discard at least one fourth duplicated PDCP PDU and/or RLC SDU associated with the uplink radio bearer and the at least one RLC entity.

In an embodiment, the relay UE 850 may further comprise a fourth receiving module 857 configured to receive a signaling comprising an identifier of the first UE from the network node. The signaling indicates discarding duplicated PDCP PDUs and/or RLC SDUs associated with the uplink radio bearer. The relay UE 850 may further comprise a third discarding module 858 configured to discard duplicated PDCP PDUs and/or RLC SDUs associated with the uplink radio bearer.

In an embodiment, the relay UE 850 may further comprise a fifth receiving module 859 configured to receive a signaling comprising an identifier of the first UE from the network node. The signaling indicates deactivating at least one RLC entity of the uplink radio bearer in the UE-to-network relay path. The relay UE 850 may further comprise a deactivating module 860 configured to deactivate at least one RLC entity of the uplink radio bearer in the UE-to-network relay path.

In an embodiment, the relay UE 850 may further comprise a maintaining module 861 configured to maintain a mapping table between Uu PDCP PDUs and sidelink RLC PDU in the UE-to-network relay path.

FIG. 8c is a block diagram showing a network node according to an embodiment of the disclosure. As shown, the network node 880 comprises a first determining module 881 configured to, for a downlink radio bearer that has been activated with PDCP duplication, determine that a PDCP PDU has been successfully delivered to a first UE via a relay UE on a UE-to-network relay path. The network node 880 may further comprise a discarding module 882 configured to discard at least one duplicated PDCP PDU on at least one other UE-to-network path.

In an embodiment, the network node 880 may further comprise a second determining module 883 configured to determine to deactivate the PDCP duplication of the downlink radio bearer.

In an embodiment, the network node 880 may further comprise a performing module 884 configured to perform at least one of: deactivating the PDCP duplication of the downlink radio bearer; sending a third signaling to the first UE; sending a fourth signaling to the first UE; sending a fifth signaling to the relay UE; discarding at least one duplicated PDCP PDU and/or RLC SDU associated with the downlink radio bearer; or sending a sixth signaling to the relay UE. The sixth signaling indicates discarding at least one second duplicated PDCP PDU and/or RLC SDU associated with the downlink radio bearer. The fifth signaling indicates deactivating at least one Uu and PC5 RLC entity for the downlink radio bearer on the UE-to-network relay path. The third signaling indicates deactivating PDCP duplication of the downlink radio bearer. The fourth signaling indicates deactivating at least one sidelink RLC entity for the downlink radio bearer on the UE-to-network relay path.

In an embodiment, the network node 880 may further comprise a maintaining module 885 configured to maintain a mapping table between Uu PDCP PDUs and Uu RLC PDU in the UE-to-network relay path.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the first UE, the relay UE or the network node may not need a fixed processor or memory, any computing resource and storage resource may be arranged from the first UE, the relay UE or the network node in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

Further, the exemplary overall commutation system including the terminal device and the network node will be introduced as below.

Embodiments of the present disclosure provide a communication system including a host computer including: processing circuitry configured to provide user data; and a communication interface configured to forward the user data to a cellular network for transmission to a terminal device. The cellular network includes a base station such as the network node above mentioned, and/or the terminal device such as the first UE and the relay UE above mentioned.

In embodiments of the present disclosure, the system further includes the terminal device. The terminal device is configured to communicate with the base station.

In embodiments of the present disclosure, the processing circuitry of the host computer is configured to execute a host application, thereby providing the user data; and the terminal device includes processing circuitry configured to execute a client application associated with the host application.

Embodiments of the present disclosure also provide a communication system including a host computer including: a communication interface configured to receive user data originating from a transmission from a terminal device; a base station. The transmission is from the terminal device to the base station. The base station is above mentioned network node, and/or the terminal device is above mentioned.

In embodiments of the present disclosure, the processing circuitry of the host computer is configured to execute a host application. The terminal device is configured to execute a client application associated with the host application, thereby providing the user data to be received by the host computer.

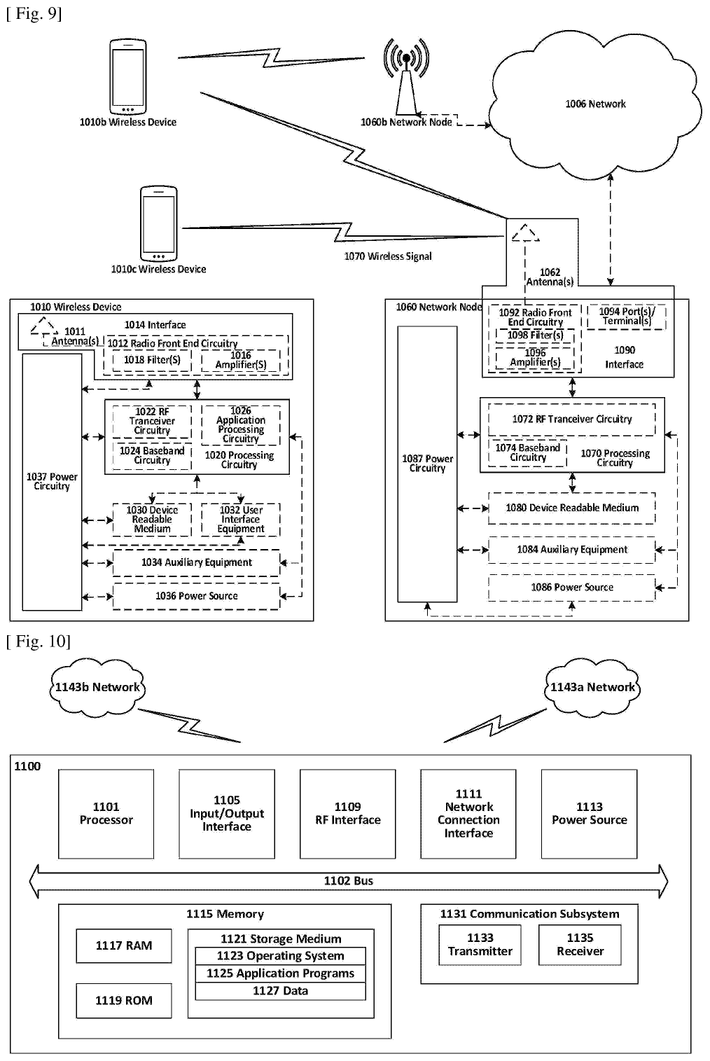

FIG. 9 is a schematic showing a wireless network in accordance with some embodiments.

Although the subject matter described herein may be implemented in any appropriate type of system using any suitable components, the embodiments disclosed herein are described in relation to a wireless network, such as the example wireless network illustrated in FIG. 9. For simplicity, the wireless network of FIG. 9 only depicts network 1006, network nodes 1060 (corresponding to network side node) and 1060b, and WDs (corresponding to terminal device) 1010, 1010b, and 1010c. In practice, a wireless network may further include any additional elements suitable to support communication between wireless devices or between a wireless device and another communication device, such as a landline telephone, a service provider, or any other network node or end device. Of the illustrated components, network node 1060 and wireless device (WD) 1010 are depicted with additional detail. The wireless network may provide communication and other types of services to one or more wireless devices to facilitate the wireless devices' access to and/or use of the services provided by, or via, the wireless network.

The wireless network may comprise and/or interface with any type of

communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1006 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1060 and WD 1010 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 9, network node 1060 includes processing circuitry 1070, device readable medium 1080, interface 1090, auxiliary equipment 1084, power source 1086, power circuitry 1087, and antenna 1062. Although network node 1060 illustrated in the example wireless network of FIG. 9 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1060 are depicted as single boxes located within a larger box, or nested within multiple boxes, in practice, a network node may comprise multiple different physical components that make up a single illustrated component (e.g., device readable medium 1080 may comprise multiple separate hard drives as well as multiple RAM modules).

Similarly, network node 1060 may be composed of multiple physically separate components (e.g., a NodeB component and a RNC component, or a BTS component and a BSC component, etc.), which may each have their own respective components. In certain scenarios in which network node 1060 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1060 may be configured to support multiple radio access technologies (RATs). In such embodiments, some components may be duplicated (e.g., separate device readable medium 1080 for the different RATs) and some components may be reused (e.g., the same antenna 1062 may be shared by the RATs). Network node 1060 may also include multiple sets of the various illustrated components for different wireless technologies integrated into network node 1060, such as, for example, GSM, WCDMA, LTE, NR, WiFi, or Bluetooth wireless technologies. These wireless technologies may be integrated into the same or different chip or set of chips and other components within network node 1060.

Processing circuitry 1070 is configured to perform any determining, calculating, or similar operations (e.g., certain obtaining operations) described herein as being provided by a network node. These operations performed by processing circuitry 1070 may include processing information obtained by processing circuitry 1070 by, for example, converting the obtained information into other information, comparing the obtained information or converted information to information stored in the network node, and/or performing one or more operations based on the obtained information or converted information, and as a result of said processing making a determination.

Processing circuitry 1070 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, cither alone or in conjunction with other network node 1060 components, such as device readable medium 1080, network node 1060 functionality. For example, processing circuitry 1070 may execute instructions stored in device readable medium 1080 or in memory within processing circuitry 1070. Such functionality may include providing any of the various wireless features, functions, or benefits discussed herein. In some embodiments, processing circuitry 1070 may include a system on a chip (SOC).

In some embodiments, processing circuitry 1070 may include one or more of radio frequency (RF) transceiver circuitry 1072 and baseband processing circuitry 1074. In some embodiments, radio frequency (RF) transceiver circuitry 1072 and baseband processing circuitry 1074 may be on separate chips (or sets of chips), boards, or units, such as radio units and digital units. In alternative embodiments, part or all of RF transceiver circuitry 1072 and baseband processing circuitry 1074 may be on the same chip or set of chips, boards, or units

In certain embodiments, some or all of the functionality described herein as being provided by a network node, base station, eNB or other such network node may be performed by processing circuitry 1070 executing instructions stored on device readable medium 1080 or memory within processing circuitry 1070. In alternative embodiments, some or all of the functionality may be provided by processing circuitry 1070 without executing instructions stored on a separate or discrete device readable medium, such as in a hard-wired manner. In any of those embodiments, whether executing instructions stored on a device readable storage medium or not, processing circuitry 1070 can be configured to perform the described functionality. The benefits provided by such functionality are not limited to processing circuitry 1070 alone or to other components of network node 1060, but are enjoyed by network node 1060 as a whole, and/or by end users and the wireless network generally.

Device readable medium 1080 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non- transitory device readable and/or computer-executable memory devices that store information, data, and/or instructions that may be used by processing circuitry 1070. Device readable medium 1080 may store any suitable instructions, data or information, including a computer program, software, an application including one or more of logic, rules, code, tables, etc. and/or other instructions capable of being executed by processing circuitry 1070 and, utilized by network node 1060. Device readable medium 1080 may be used to store any calculations made by processing circuitry 1070 and/or any data received via interface 1090. In some embodiments, processing circuitry 1070 and device readable medium 1080 may be considered to be integrated.

Interface 1090 is used in the wired or wireless communication of signalling and/or data between network node 1060, network 1006, and/or WDs 1010. As illustrated, interface 1090 comprises port(s)/terminal(s) 1094 to send and receive data, for example to and from network 1006 over a wired connection. Interface 1090 also includes radio front end circuitry 1092 that may be coupled to, or in certain embodiments a part of, antenna 1062. Radio front end circuitry 1092 comprises filters 1098 and amplifiers 1096. Radio front end circuitry 1092 may be connected to antenna 1062 and processing circuitry 1070. Radio front end circuitry may be configured to condition signals communicated between antenna 1062 and processing circuitry 1070. Radio front end circuitry 1092 may receive digital data that is to be sent out to other network nodes or WDs via a wireless connection. Radio front end circuitry 1092 may convert the digital data into a radio signal having the appropriate channel and bandwidth parameters using a combination of filters 1098 and/or amplifiers 1096. The radio signal may then be transmitted via antenna 1062. Similarly, when receiving data, antenna 1062 may collect radio signals which are then converted into digital data by radio front end circuitry 1092. The digital data may be passed to processing circuitry 1070. In other embodiments, the interface may comprise different components and/or different combinations of components.

In certain alternative embodiments, network node 1060 may not include separate radio front end circuitry 1092, instead, processing circuitry 1070 may comprise radio front end circuitry and may be connected to antenna 1062 without separate radio front end circuitry 1092. Similarly, in some embodiments, all or some of RF transceiver circuitry 1072 may be considered a part of interface 1090. In still other embodiments, interface 1090 may include one or more ports or terminals 1094, radio front end circuitry 1092, and RF transceiver circuitry 1072, as part of a radio unit (not shown), and interface 1090 may communicate with baseband processing circuitry 1074, which is part of a digital unit (not shown).

Antenna 1062 may include one or more antennas, or antenna arrays, configured to send and/or receive wireless signals. Antenna 1062 may be coupled to radio front end circuitry 1090 and may be any type of antenna capable of transmitting and receiving data and/or signals wirelessly. In some embodiments, antenna 1062 may comprise one or more omni-directional, sector or panel antennas operable to transmit/receive radio signals between, for example, 2 GHZ and 66 GHZ. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1062 may be separate from network node 1060 and may be connectable to network node 1060 through an interface or port.

Antenna 1062, interface 1090, and/or processing circuitry 1070 may be configured to perform any receiving operations and/or certain obtaining operations described herein as being performed by a network node. Any information, data and/or signals may be received from a wireless device, another network node and/or any other network equipment. Similarly, antenna 1062, interface 1090, and/or processing circuitry 1070 may be configured to perform any transmitting operations described herein as being performed by a network node. Any information, data and/or signals may be transmitted to a wireless device, another network node and/or any other network equipment.

Power circuitry 1087 may comprise, or be coupled to, power management circuitry and is configured to supply the components of network node 1060 with power for performing the functionality described herein. Power circuitry 1087 may receive power from power source 1086. Power source 1086 and/or power circuitry 1087 may be configured to provide power to the various components of network node 1060 in a form suitable for the respective components (e.g., at a voltage and current level needed for each respective component). Power source 1086 may either be included in, or external to, power circuitry 1087 and/or network node 1060. For example, network node 1060 may be connectable to an external power source (e.g., an electricity outlet) via an input circuitry or interface such as an electrical cable, whereby the external power source supplies power to power circuitry 1087. As a further example, power source 1086 may comprise a source of power in the form of a battery or battery pack which is connected to, or integrated in, power circuitry 1087. The battery may provide backup power should the external power source fail. Other types of power sources, such as photovoltaic devices, may also be used.

Alternative embodiments of network node 1060 may include additional components beyond those shown in FIG. 9 that may be responsible for providing certain aspects of the network node's functionality, including any of the functionality described herein and/or any functionality necessary to support the subject matter described herein. For example, network node 1060 may include user interface equipment to allow input of information into network node 1060 and to allow output of information from network node 1060. This may allow a user to perform diagnostic, maintenance, repair, and other administrative functions for network node 1060.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1010 includes antenna 1011, interface 1014, processing circuitry 1020, device readable medium 1030, user interface equipment 1032, auxiliary equipment 1034, power source 1036 and power circuitry 1037. WD 1010 may include multiple sets of one or more of the illustrated components for different wireless technologies supported by WD 1010, such as, for example, GSM, WCDMA, LTE, NR, WiFi, WiMAX, or Bluetooth wireless technologies, just to mention a few. These wireless technologies may be integrated into the same or different chips or set of chips as other components within WD 1010.

Antenna 1011 may include one or more antennas or antenna arrays, configured to send and/or receive wireless signals, and is connected to interface 1014. In certain alternative embodiments, antenna 1011 may be separate from WD 1010 and be connectable to WD 1010 through an interface or port. Antenna 1011, interface 1014, and/or processing circuitry 1020 may be configured to perform any receiving or transmitting operations described herein as being performed by a WD. Any information, data and/or signals may be received from a network node and/or another WD. In some embodiments, radio front end circuitry and/or antenna 1011 may be considered an interface.

As illustrated, interface 1014 comprises radio front end circuitry 1012 and antenna 1011. Radio front end circuitry 1012 comprise one or more filters 1018 and amplifiers 1016. Radio front end circuitry 1014 is connected to antenna 1011 and processing circuitry 1020, and is configured to condition signals communicated between antenna 1011 and processing circuitry 1020. Radio front end circuitry 1012 may be coupled to or a part of antenna 1011. In some embodiments, WD 1010 may not include separate radio front end circuitry 1012; rather, processing circuitry 1020 may comprise radio front end circuitry and may be connected to antenna 1011. Similarly, in some embodiments, some or all of RF transceiver circuitry 1022 may be considered a part of interface 1014. Radio front end circuitry 1012 may receive digital data that is to be sent out to other network nodes or WDs via a wireless connection. Radio front end circuitry 1012 may convert the digital data into a radio signal having the appropriate channel and bandwidth parameters using a combination of filters 1018 and/or amplifiers 1016. The radio signal may then be transmitted via antenna 1011. Similarly, when receiving data, antenna 1011 may collect radio signals which are then converted into digital data by radio front end circuitry 1012. The digital data may be passed to processing circuitry 1020. In other embodiments, the interface may comprise different components and/or different combinations of components.

Processing circuitry 1020 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1010 components, such as device readable medium 1030, WD 1010 functionality. Such functionality may include providing any of the various wireless features or benefits discussed herein. For example, processing circuitry 1020 may execute instructions stored in device readable medium 1030 or in memory within processing circuitry 1020 to provide the functionality disclosed herein.

As illustrated, processing circuitry 1020 includes one or more of RF transceiver circuitry 1022, baseband processing circuitry 1024, and application processing circuitry 1026. In other embodiments, the processing circuitry may comprise different components and/or different combinations of components. In certain embodiments processing circuitry 1020 of WD 1010 may comprise a SOC. In some embodiments, RF transceiver circuitry 1022, baseband processing circuitry 1024, and application processing circuitry 1026 may be on separate chips or sets of chips. In alternative embodiments, part or all of baseband processing circuitry 1024 and application processing circuitry 1026 may be combined into one chip or set of chips, and RF transceiver circuitry 1022 may be on a separate chip or set of chips. In still alternative embodiments, part or all of RF transceiver circuitry 1022 and baseband processing circuitry 1024 may be on the same chip or set of chips, and application processing circuitry 1026 may be on a separate chip or set of chips. In yet other alternative embodiments, part or all of RF transceiver circuitry 1022, baseband processing circuitry 1024, and application processing circuitry 1026 may be combined in the same chip or set of chips. In some embodiments, RF transceiver circuitry 1022 may be a part of interface 1014. RF transceiver circuitry 1022 may condition RF signals for processing circuitry 1020.

In certain embodiments, some or all of the functionality described herein as being performed by a WD may be provided by processing circuitry 1020 executing instructions stored on device readable medium 1030, which in certain embodiments may be a computer-readable storage medium. In alternative embodiments, some or all of the functionality may be provided by processing circuitry 1020 without executing instructions stored on a separate or discrete device readable storage medium, such as in a hard-wired manner. In any of those particular embodiments, whether executing instructions stored on a device readable storage medium or not, processing circuitry 1020 can be configured to perform the described functionality. The benefits provided by such functionality are not limited to processing circuitry 1020 alone or to other components of WD 1010, but are enjoyed by WD 1010 as a whole, and/or by end users and the wireless network generally.

Processing circuitry 1020 may be configured to perform any determining, calculating, or similar operations (e.g., certain obtaining operations) described herein as being performed by a WD. These operations, as performed by processing circuitry 1020, may include processing information obtained by processing circuitry 1020 by, for example, converting the obtained information into other information, comparing the obtained information or converted information to information stored by WD 1010, and/or performing one or more operations based on the obtained information or converted information, and as a result of said processing making a determination.

Device readable medium 1030 may be operable to store a computer program, software, an application including one or more of logic, rules, code, tables, etc. and/or other instructions capable of being executed by processing circuitry 1020. Device readable medium 1030 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1020. In some embodiments, processing circuitry 1020 and device readable medium 1030 may be considered to be integrated.

User interface equipment 1032 may provide components that allow for a human user to interact with WD 1010. Such interaction may be of many forms, such as visual, audial, tactile, etc. User interface equipment 1032 may be operable to produce output to the user and to allow the user to provide input to WD 1010. The type of interaction may vary depending on the type of user interface equipment 1032 installed in WD 1010. For example, if WD 1010 is a smart phone, the interaction may be via a touch screen; if WD 1010 is a smart meter, the interaction may be through a screen that provides usage (e.g., the number of gallons used) or a speaker that provides an audible alert (e.g., if smoke is detected). User interface equipment 1032 may include input interfaces, devices and circuits, and output interfaces, devices and circuits. User interface equipment 1032 is configured to allow input of information into WD 1010, and is connected to processing circuitry 1020 to allow processing circuitry 1020 to process the input information. User interface equipment 1032 may include, for example, a microphone, a proximity or other sensor, keys/buttons, a touch display, one or more cameras, a USB port, or other input circuitry. User interface equipment 1032 is also configured to allow output of information from WD 1010, and to allow processing circuitry 1020 to output information from WD 1010. User interface equipment 1032 may include, for example, a speaker, a display, vibrating circuitry, a USB port, a headphone interface, or other output circuitry. Using one or more input and output interfaces, devices, and circuits, of user interface equipment 1032, WD 1010 may communicate with end users and/or the wireless network, and allow them to benefit from the functionality described herein.

Auxiliary equipment 1034 is operable to provide more specific functionality which may not be generally performed by WDs. This may comprise specialized sensors for doing measurements for various purposes, interfaces for additional types of communication such as wired communications etc. The inclusion and type of components of auxiliary equipment 1034 may vary depending on the embodiment and/or scenario.

Power source 1036 may, in some embodiments, be in the form of a battery or battery pack. Other types of power sources, such as an external power source (e.g., an electricity outlet), photovoltaic devices or power cells, may also be used. WD 1010 may further comprise power circuitry 1037 for delivering power from power source 1036 to the various parts of WD 1010 which need power from power source 1036 to carry out any functionality described or indicated herein. Power circuitry 1037 may in certain embodiments comprise power management circuitry. Power circuitry 1037 may additionally or alternatively be operable to receive power from an external power source; in which case WD 1010 may be connectable to the external power source (such as an electricity outlet) via input circuitry or an interface such as an electrical power cable. Power circuitry 1037 may also in certain embodiments be operable to deliver power from an external power source to power source 1036. This may be, for example, for the charging of power source 1036. Power circuitry 1037 may perform any formatting, converting, or other modification to the power from power source 1036 to make the power suitable for the respective components of WD 1010 to which power is supplied.

FIG. 10 is a schematic showing a user equipment in accordance with some embodiments.

FIG. 10 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1100 may be any UE identified by the 3rd Generation Partnership Project (3GPP), including a NB-IoT UE, a machine type communication (MTC) UE, and/or an enhanced MTC (eMTC) UE. UE 1100, as illustrated in FIG. 10, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 10 is a UE, the components discussed herein are equally applicable to a WD, and vice-versa.

In FIG. 10, UE 1100 includes processing circuitry 1101 that is operatively coupled to input/output interface 1105, radio frequency (RF) interface 1109, network connection interface 1111, memory 1115 including random access memory (RAM) 1117, read-only memory (ROM) 1119, and storage medium 1121 or the like, communication subsystem 1131, power source 1133, and/or any other component, or any combination thereof. Storage medium 1121 includes operating system 1123, application program 1125, and data 1127. In other embodiments, storage medium 1121 may include other similar types of information. Certain UEs may utilize all of the components shown in FIG. 10, or only a subset of the components. The level of integration between the components may vary from one UE to another UE. Further, certain UEs may contain multiple instances of a component, such as multiple processors, memories, transceivers, transmitters, receivers, etc.

In FIG. 10, processing circuitry 1101 may be configured to process computer instructions and data. Processing circuitry 1101 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1101 may include two central processing units (CPUs). Data may be information in a form suitable for use by a computer.

In the depicted embodiment, input/output interface 1105 may be configured to provide a communication interface to an input device, output device, or input and output device. UE 1100 may be configured to use an output device via input/output interface 1105. An output device may use the same type of interface port as an input device. For example, a USB port may be used to provide input to and output from UE 1100. The output device may be a speaker, a sound card, a video card, a display, a monitor, a printer, an actuator, an emitter, a smartcard, another output device, or any combination thereof. UE 1100 may be configured to use an input device via input/output interface 1105 to allow a user to capture information into UE 1100. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 10, RF interface 1109 may be configured to provide a communication interface to RF components such as a transmitter, a receiver, and an antenna. Network connection interface 1111 may be configured to provide a communication interface to network 1143a. Network 1143a may encompass wired and/or wireless networks such as a local-area network (LAN), a wide-area network (WAN), a computer network, a wireless network, a telecommunications network, another like network or any combination thereof. For example, network 1143a may comprise a Wi-Fi network. Network connection interface 1111 may be configured to include a receiver and a transmitter interface used to communicate with one or more other devices over a communication network according to one or more communication protocols, such as Ethernet, TCP/IP, SONET, ATM, or the like. Network connection interface 1111 may implement receiver and transmitter functionality appropriate to the communication network links (e.g., optical, electrical, and the like). The transmitter and receiver functions may share circuit components, software or firmware, or alternatively may be implemented separately.

RAM 1117 may be configured to interface via bus 1102 to processing circuitry 1101 to provide storage or caching of data or computer instructions during the execution of software programs such as the operating system, application programs, and device drivers. ROM 1119 may be configured to provide computer instructions or data to processing circuitry 1101. For example, ROM 1119 may be configured to store invariant low-level system code or data for basic system functions such as basic input and output (I/O), startup, or reception of keystrokes from a keyboard that are stored in a non-volatile memory. Storage medium 1121 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1121 may be configured to include operating system 1123, application program 1125 such as a web browser application, a widget or gadget engine or another application, and data file 1127. Storage medium 1121 may store, for use by UE 1100, any of a variety of various operating systems or combinations of operating systems.

Storage medium 1121 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1121 may allow UE 1100 to access computer-executable instructions, application programs or the like, stored on transitory or non-transitory memory media, to off-load data, or to upload data. An article of manufacture, such as one utilizing a communication system may be tangibly embodied in storage medium 1121, which may comprise a device readable medium.

In FIG. 10, processing circuitry 1101 may be configured to communicate with network 1143b using communication subsystem 1131. Network 1143a and network 1143b may be the same network or networks or different network or networks. Communication subsystem 1131 may be configured to include one or more transceivers used to communicate with network 1143b. For example, communication subsystem 1131 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1133 and/or receiver 1135 to implement transmitter or receiver functionality, respectively, appropriate to the RAN links (e.g., frequency allocations and the like). Further, transmitter 1133 and receiver 1135 of each transceiver may share circuit components, software or firmware, or alternatively may be implemented separately.

In the illustrated embodiment, the communication functions of communication subsystem 1131 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1131 may include cellular communication, Wi-Fi communication, Bluetooth communication, and GPS communication. Network 1143b may encompass wired and/or wireless networks such as a local-area network (LAN), a wide-area network (WAN), a computer network, a wireless network, a telecommunications network, another like network or any combination thereof. For example, network 1143b may be a cellular network, a Wi-Fi network, and/or a near-field network. Power source 1113 may be configured to provide alternating current (AC) or direct current (DC) power to components of UE 1100.

The features, benefits and/or functions described herein may be implemented in one of the components of UE 1100 or partitioned across multiple components of UE 1100. Further, the features, benefits, and/or functions described herein may be implemented in any combination of hardware, software or firmware. In one example, communication subsystem 1131 may be configured to include any of the components described herein. Further, processing circuitry 1101 may be configured to communicate with any of such components over bus 1102. In another example, any of such components may be represented by program instructions stored in memory that when executed by processing circuitry 1101 perform the corresponding functions described herein. In another example, the functionality of any of such components may be partitioned between processing circuitry 1101 and communication subsystem 1131. In another example, the non-computationally intensive functions of any of such components may be implemented in software or firmware and the computationally intensive functions may be implemented in hardware.

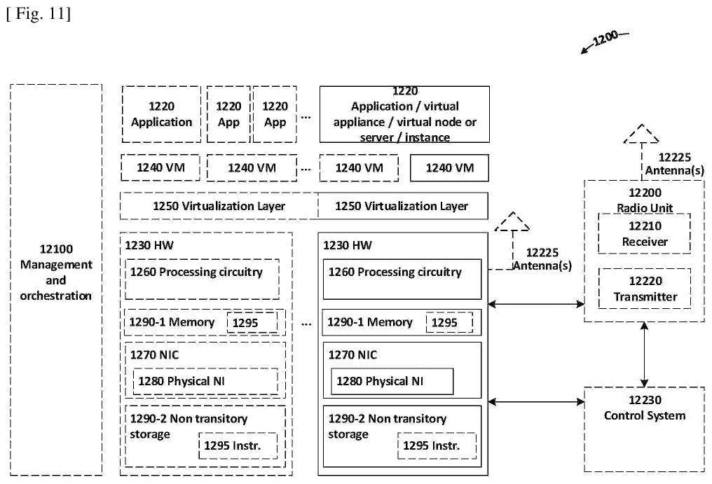

FIG. 11 is a schematic showing a virtualization environment in accordance with some embodiments.

FIG. 11 is a schematic block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1200 hosted by one or more of hardware nodes 1230. Further, in embodiments in which the virtual node is not a radio access node or does not require radio connectivity (e.g., a core network node), then the network node may be entirely virtualized.

The functions may be implemented by one or more applications 1220 (which may alternatively be called software instances, virtual appliances, network functions, virtual nodes, virtual network functions, etc.) operative to implement some of the features, functions, and/or benefits of some of the embodiments disclosed herein. Applications 1220 are run in virtualization environment 1200 which provides hardware 1230 comprising processing circuitry 1260 and memory 1290-1. Memory 1290-1 contains instructions 1295 executable by processing circuitry 1260 whereby application 1220 is operative to provide one or more of the features, benefits, and/or functions disclosed herein.

Virtualization environment 1200, comprises general-purpose or special-purpose network hardware devices 1230 comprising a set of one or more processors or processing circuitry 1260, which may be commercial off-the-shelf (COTS) processors, dedicated Application Specific Integrated Circuits (ASICs), or any other type of processing circuitry including digital or analog hardware components or special purpose processors. Each hardware device may comprise memory 1290-1 which may be non-persistent memory for temporarily storing instructions 1295 or software executed by processing circuitry 1260. Each hardware device may comprise one or more network interface controllers (NICs) 1270, also known as network interface cards, which include physical network interface 1280. Each hardware device may also include non-transitory, persistent, machine-readable storage media 1290-2 having stored therein software 1295 and/or instructions executable by processing circuitry 1260. Software 1295 may include any type of software including software for instantiating one or more virtualization layers 1250 (also referred to as hypervisors), software to execute virtual machines 1240 as well as software allowing it to execute functions, features and/or benefits described in relation with some embodiments described herein.

Virtual machines 1240, comprise virtual processing, virtual memory, virtual networking or interface and virtual storage, and may be run by a corresponding virtualization layer 1250 or hypervisor. Different embodiments of the instance of virtual appliance 1220 may be implemented on one or more of virtual machines 1240, and the implementations may be made in different ways.

During operation, processing circuitry 1260 executes software 1295 to instantiate the hypervisor or virtualization layer 1250, which may sometimes be referred to as a virtual machine monitor (VMM). Virtualization layer 1250 may present a virtual operating platform that appears like networking hardware to virtual machine 1240.

As shown in FIG. 11, hardware 1230 may be a standalone network node with generic or specific components. Hardware 1230 may comprise antenna 12225 and may implement some functions via virtualization. Alternatively, hardware 1230 may be part of a larger cluster of hardware (e.g. such as in a data center or customer premise equipment (CPE)) where many hardware nodes work together and are managed via management and orchestration (MANO) 12100, which, among others, oversees lifecycle management of applications 1220.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1240 may be a software implementation of a physical machine that runs programs as if they were executing on a physical, non-virtualized machine. Each of virtual machines 1240, and that part of hardware 1230 that executes that virtual machine, be it hardware dedicated to that virtual machine and/or hardware shared by that virtual machine with others of the virtual machines 1240, forms a separate virtual network elements (VNE).

Still in the context of NFV, Virtual Network Function (VNF) is responsible for handling specific network functions that run in one or more virtual machines 1240 on top of hardware networking infrastructure 1230 and corresponds to application 1220 in FIG. 11.

In some embodiments, one or more radio units 12200 that each include one or more transmitters 12220 and one or more receivers 12210 may be coupled to one or more antennas 12225. Radio units 12200 may communicate directly with hardware nodes 1230 via one or more appropriate network interfaces and may be used in combination with the virtual components to provide a virtual node with radio capabilities, such as a radio access node or a base station.

In some embodiments, some signalling can be effected with the use of control system 12230 which may alternatively be used for communication between the hardware nodes 1230 and radio units 12200.

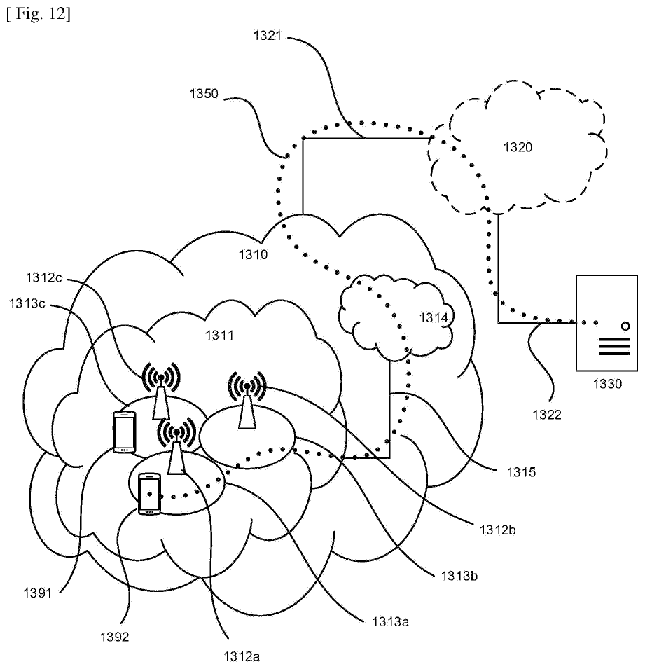

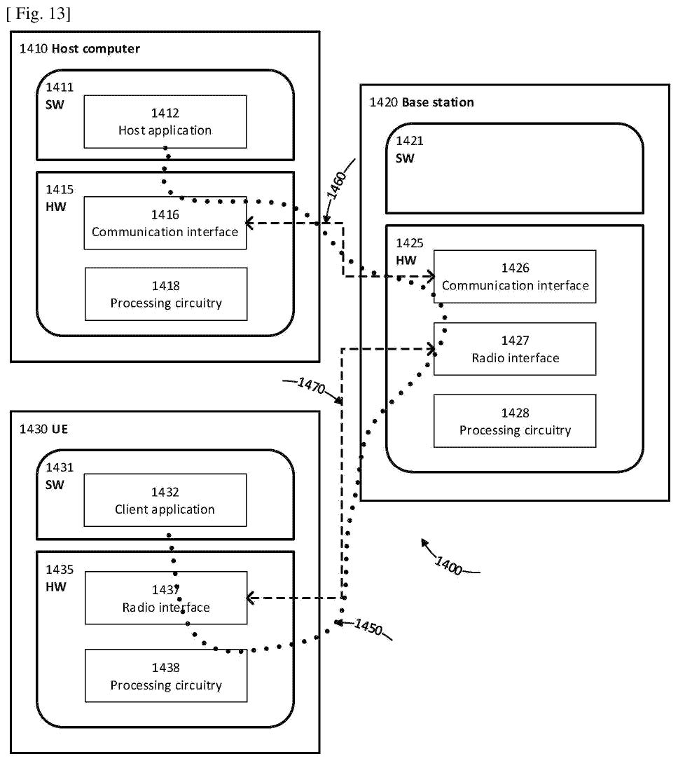

FIG. 12 is a schematic showing a telecommunication network connected via an intermediate network to a host computer in accordance with some embodiments.

With reference to FIG. 12, in accordance with an embodiment, a communication system includes telecommunication network 1310, such as a 3GPP-type cellular network, which comprises access network 1311, such as a radio access network, and core network 1314. Access network 1311 comprises a plurality of base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to core network 1314 over a wired or wireless connection 1315. A first UE 1391 located in coverage area 1313c is configured to wirelessly connect to, or be paged by, the corresponding base station 1312c. A relay UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312a or 1312b or 1312c.

Telecommunication network 1310 is itself connected to host computer 1330, which may be embodied in the hardware and/or software of a standalone server, a cloud-implemented server, a distributed server or as processing resources in a server farm. Host computer 1330 may be under the ownership or control of a service provider, or may be operated by the service provider or on behalf of the service provider. Connections 1321 and 1322 between telecommunication network 1310 and host computer 1330 may extend directly from core network 1314 to host computer 1330 or may go via an optional intermediate network 1320. Intermediate network 1320 may be one of, or a combination of more than one of, a public, private or hosted network; intermediate network 1320, if any, may be a backbone network or the Internet; in particular, intermediate network 1320 may comprise two or more sub-networks (not shown).

The communication system of FIG. 12 as a whole enables connectivity between the connected UEs 1391, 1392 and host computer 1330. The connectivity may be described as an over-the-top (OTT) connection 1350. Host computer 1330 and the connected UEs 1391, 1392 are configured to communicate data and/or signalling via OTT connection 1350, using access network 1311, core network 1314, any intermediate network 1320 and possible further infrastructure (not shown) as intermediaries. OTT connection 1350 may be transparent in the sense that the participating communication devices through which OTT connection 1350 passes are unaware of routing of uplink and downlink communications. For example, base station 1312a or 1312b or 1312c may not or need not be informed about the past routing of an incoming downlink communication with data originating from host computer 1330 to be forwarded (e.g., handed over) to a connected UE 1391. Similarly, base station 1312a or 1312b or 1312c need not be aware of the future routing of an outgoing uplink communication originating from the UE 1391 towards the host computer 1330.

FIG. 13 is a schematic showing a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 13. In communication system 1400, host computer 1410 comprises hardware 1415 including communication interface 1416 configured to set up and maintain a wired or wireless connection with an interface of a different communication device of communication system 1400. Host computer 1410 may further comprise processing circuitry 1418, which may have storage and/or processing capabilities. In particular, processing circuitry 1418 may comprise one or more programmable processors, application-specific integrated circuits, field programmable gate arrays or combinations of these (not shown) adapted to execute instructions. Host computer 1410 may further comprise software 1411, which is stored in or accessible by host computer 1410 and executable by processing circuitry 1418. Software 1411 includes host application 1412. Host application 1412 may be operable to provide a service to a remote user, such as UE 1430 connecting via OTT connection 1450 terminating at UE 1430 and host computer 1410. In providing the service to the remote user, host application 1412 may provide user data which is transmitted using OTT connection 1450.

Communication system 1400 further includes base station 1420 provided in a telecommunication system and comprising hardware 1425 enabling it to communicate with host computer 1410 and with UE 1430. Hardware 1425 may include communication interface 1426 for setting up and maintaining a wired or wireless connection with an interface of a different communication device of communication system 1400, as well as radio interface 1427 for setting up and maintaining at least wireless connection 1470 with UE 1430 located in a coverage area (not shown in FIG. 13) served by base station 1420. Communication interface 1426 may be configured to facilitate connection 1460 to host computer 1410. Connection 1460 may be direct or it may pass through a core network (not shown in FIG. 13) of the telecommunication system and/or through one or more intermediate networks outside the telecommunication system. In the embodiment shown, hardware 1425 of base station 1420 further includes processing circuitry 1428, which may comprise one or more programmable processors, application-specific integrated circuits, field programmable gate arrays or combinations of these (not shown) adapted to execute instructions. Base station 1420 further has software 1421 stored internally or accessible via an external connection.

Communication system 1400 further includes UE 1430 already referred to. Its hardware 1435 may include radio interface 1437 configured to set up and maintain wireless connection 1470 with a base station serving a coverage area in which UE 1430 is currently located. Hardware 1435 of UE 1430 further includes processing circuitry 1438, which may comprise one or more programmable processors, application-specific integrated circuits, field programmable gate arrays or combinations of these (not shown) adapted to execute instructions. UE 1430 may further comprise software 1431, which is stored in or accessible by UE 1430 and executable by processing circuitry 1438. Software 1431 includes client application 1432. Client application 1432 may be operable to provide a service to a human or non-human user via UE 1430, with the support of host computer 1410. In host computer 1410, an executing host application 1412 may communicate with the executing client application 1432 via OTT connection 1450 terminating at UE 1430 and host computer 1410. In providing the service to the user, client application 1432 may receive request data from host application 1412 and provide user data in response to the request data. OTT connection 1450 may transfer both the request data and the user data. Client application 1432 may interact with the user to generate the user data that it provides.

It is noted that host computer 1410, base station 1420 and UE 1430 illustrated in FIG. 13 may be similar or identical to host computer 1330, one of base stations 1312a, 1312b, 1312c and one of UEs 1391, 1392 of FIG. 12, respectively. This is to say, the inner workings of these entities may be as shown in FIG. 13 and independently, the surrounding network topology may be that of FIG. 12.

In FIG. 13, OTT connection 1450 has been drawn abstractly to illustrate the communication between host computer 1410 and UE 1430 via base station 1420, without explicit reference to any intermediary devices and the precise routing of messages via these devices. Network infrastructure may determine the routing, which it may be configured to hide from UE 1430 or from the service provider operating host computer 1410, or both. While OTT connection 1450 is active, the network infrastructure may further take decisions by which it dynamically changes the routing (e.g., on the basis of load balancing consideration or reconfiguration of the network).

Wireless connection 1470 between UE 1430 and base station 1420 is in accordance with the teachings of the embodiments described throughout this disclosure. One or more of the various embodiments improve the performance of OTT services provided to UE 1430 using OTT connection 1450, in which wireless connection 1470 forms the last segment. More precisely, in some embodiments herein, it can avoid redundant duplicate PDUs to be transmitted. In some embodiments herein, it can ensure PDCP duplication to work properly in Uu and SL mixed multi-path scenarios.

A measurement procedure may be provided for the purpose of monitoring data rate, latency and other factors on which the one or more embodiments improve. There may further be an optional network functionality for reconfiguring OTT connection 1450 between host computer 1410 and UE 1430, in response to variations in the measurement results. The measurement procedure and/or the network functionality for reconfiguring OTT connection 1450 may be implemented in software 1411 and hardware 1415 of host computer 1410 or in software 1431 and hardware 1435 of UE 1430, or both. In embodiments, sensors (not shown) may be deployed in or in association with communication devices through which OTT connection 1450 passes; the sensors may participate in the measurement procedure by supplying values of the monitored quantities exemplified above, or supplying values of other physical quantities from which software 1411, 1431 may compute or estimate the monitored quantities. The reconfiguring of OTT connection 1450 may include message format, retransmission settings, preferred routing etc.; the reconfiguring need not affect base station 1420, and it may be unknown or imperceptible to base station 1420. Such procedures and functionalities may be known and practiced in the art. In certain embodiments, measurements may involve proprietary UE signalling facilitating host computer 1410's measurements of throughput, propagation times, latency and the like. The measurements may be implemented in that software 1411 and 1431 causes messages to be transmitted, in particular empty or ‘dummy’ messages, using OTT connection 1450 while it monitors propagation times, errors etc.

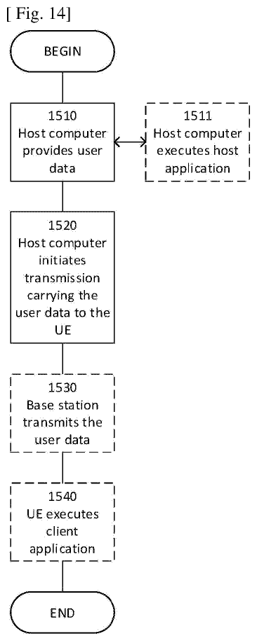

FIG. 14 is a schematic showing methods implemented in a communication system including a host computer, a base station and a user equipment in accordance with some embodiments.

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In step 1510, the host computer provides user data. In substep 1511 (which may be optional) of step 1510, the host computer provides the user data by executing a host application. In step 1520, the host computer initiates a transmission carrying the user data to the UE. In step 1530 (which may be optional), the base station transmits to the UE the user data which was carried in the transmission that the host computer initiated, in accordance with the teachings of the embodiments described throughout this disclosure. In step 1540 (which may also be optional), the UE executes a client application associated with the host application executed by the host computer.

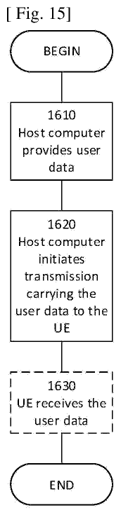

FIG. 15 is a schematic showing methods implemented in a communication system including a host computer, a base station and a user equipment in accordance with some embodiments.

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In step 1610 of the method, the host computer provides user data. In an optional substep (not shown) the host computer provides the user data by executing a host application. In step 1620, the host computer initiates a transmission carrying the user data to the UE. The transmission may pass via the base station, in accordance with the teachings of the embodiments described throughout this disclosure. In step 1630 (which may be optional), the UE receives the user data carried in the transmission.

FIG. 16 is a schematic showing methods implemented in a communication system including a host computer, a base station and a user equipment in accordance with some embodiments.

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In step 1710 (which may be optional), the UE receives input data provided by the host computer. Additionally or alternatively, in step 1720, the UE provides user data. In substep 1721 (which may be optional) of step 1720, the UE provides the user data by executing a client application. In substep 1711 (which may be optional) of step 1710, the UE executes a client application which provides the user data in reaction to the received input data provided by the host computer. In providing the user data, the executed client application may further consider user input received from the user. Regardless of the specific manner in which the user data was provided, the UE initiates, in substep 1730 (which may be optional), transmission of the user data to the host computer. In step 1740 of the method, the host computer receives the user data transmitted from the UE, in accordance with the teachings of the embodiments described throughout this disclosure.

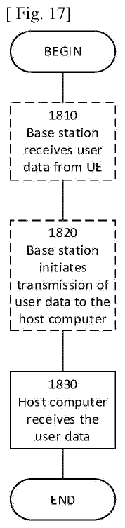

FIG. 17 is a schematic showing methods implemented in a communication system including a host computer, a base station and a user equipment in accordance with some embodiments.

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In step 1810 (which may be optional), in accordance with the teachings of the embodiments described throughout this disclosure, the base station receives user data from the UE. In step 1820 (which may be optional), the base station initiates transmission of the received user data to the host computer. In step 1830 (which may be optional), the host computer receives the user data carried in the transmission initiated by the base station.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method (300) performed by a first user equipment (UE), UE, comprising:
for an uplink radio bearer that has been activated with packet data convergence protocol (PDCP), duplication, determining that a PDCP protocol data unit (PDU),has been successfully delivered to a network node via a relay UE on a UE-to-network relay path; and
discarding at least one duplicated PDCP PDU on at least one other UE-to-network path, wherein the at least one other UE-to-network path comprises:
a UE-to-network relay path, and/or
a UE-to-network direct path.

2. (canceled)

3. The method according to claim 1, wherein determining that the PDCP PDU has been successfully delivered to the network node via the relay UE on the UE-to-network relay path comprises:
1) receiving a radio link control (RLC), status report from the relay UE, wherein the RLC status report indicates that the PDCP PDU has been successfully transmitted to the relay UE in a sidelink; and
determining that the PDCP PDU has been successfully delivered to the network node via the relay UE on the UE-to-network relay path based on the RLC status report, or
2) receiving a PDCP status report from the network node, wherein the PDCP status report indicates that the PDCP PDU has been successfully received by the network node via the UE-to-network relay path; and
determining that the PDCP PDU has been successfully delivered to the network node on the UE-to-network relay path based on the PDCP status report, or
3) receiving a first signaling from the relay UE, wherein the first signaling indicates that the relay UE has received a RLC status report for the PDCP PDU from the network node, wherein the RLC status report indicates that the PDCP PDU has been successfully transmitted to the network node in a Uu link; and
determining that the PDCP PDU has been successfully delivered to the network node via the relay UE on the UE-to-network relay path based on the first signaling, or
4) receiving a second signaling from the network node via a UE-to-network direct path, wherein the second signaling indicates that the PDCP PDU has been successfully received by the network node via the UE-to-network relay path; and
determining that the PDCP PDU has been successfully delivered to the network node via the relay UE on the UE-to-network relay path based on the second signaling.

4. (canceled)

5. The method according to claim 1, wherein the PDCP status report is received from the network node when at least one of:
an upper layer requests a PDCP entity re-establishment,
an upper layer requests a PDCP data recovery,
an upper layer requests a uplink data switching,
an upper layer reconfigures a PDCP entity to release dual active protocol stack (DAPS) and daps-SourceRelease is configured in upper layer,
an upper layer determines that a PDCP status report needs to be triggered,
a periodic timer is expired, or
PDCP duplication has been activated and at least one path for PDCP duplication is the UE-to-network relay path.

6. (canceled)

7. (canceled)

8. (canceled)

9. (canceled)

10. The method according to claim 1, further comprising:
1) receiving a third signaling from the network node, wherein the third signaling indicates deactivation of PDCP duplication of the uplink radio bearer; and
performing at least one of:
deactivating the PDCP duplication for the uplink radio bearer;
discarding at least one first duplicated PDCP PDU and/or RLC service data unit (SDU), associated with the uplink radio bearer; or
sending a fourth signaling to the relay UE, wherein the fourth signaling indicates the relay UE to discard at least one second duplicated PDCP PDU and/or RLC SDU associated with the uplink radio bearer, or
2) receiving a fifth signaling from the network node, wherein the fifth signaling indicates deactivation of PDCP duplication of the uplink radio bearer for at least one sidelink RLC entity; and
performing at least one of:
discarding at least one third duplicated PDCP PDU and/or RLC SDU associated with the uplink radio bearer of the at least one RLC entity; or
sending a sixth signaling to the relay UE, wherein the sixth signaling indicates the relay UE to discard at least one fourth duplicated PDCP PDU and/or RLC SDU associated with the uplink radio bearer and the at least one RLC entity.

11. The method according to claim 10, wherein the at least one second duplicated PDCP PDU and/or RLC SDU comprises:
one or more PDCP PDUs and/or RLC SDUs associated with the uplink radio bearer that are received from the first UE and stored in at least one sidelink RLC entity, and/or
one or more PDCP PDUs and/or RLC SDUs associated with the uplink radio bearer that are stored in at least one Uu RLC entity.

12. (canceled)

13. The method according to claim 10, wherein the at least one fourth duplicated PDCP PDU and/or RLC SDU compromises:
one or more PDCP PDUs and/or RLC SDUs associated with the uplink radio bearer that are received from the at least one RLC entity of the first UE and stored in one or more sidelink RLC entities of the relay UE, and/or
one or more PDCP PDUs and/or RLC SDUs associated with the uplink radio bearer that are received from the at least one RLC entity of the first UE and stored in at least one Uu RLC entity of the relay UE.

14. (canceled)

15. The method according to claim 1, further comprising:
maintaining a mapping table between Uu PDCP PDUs and sidelink RLC PDU in the UE-to-network relay path, wherein the mapping table comprises:
a mapping of a Uu PDCP PDU to one or multiple PC5 RLC PDUs, and/or
a mapping of one or multiple Uu PDCP PDUs to a PC5 RLC PDU.

16. (canceled)

17. (canceled)

18. The method according to claim 15, wherein an entry corresponding to a Uu PDCP PDU is added into the mapping table when the Uu PDCP PDU is delivered to a sidelink RLC layer and the entry corresponding to the Uu PDCP PDU is deleted when the sidelink RLC layer indicates to a Uu PDCP layer that the Uu PDCP PDU has been successfully transmitted to a receiver or the Uu PDCP PDU has become invalid when a timer or a counter is expired.

19. (canceled)

20. (canceled)

21. A method performed by a relay UE, comprising:
receiving a PDCP PDU of an uplink radio bearer from a first UE, wherein the uplink radio bearer has been activated with PDCP duplication; and
sending an indication that the PDCP PDU has been successfully delivered to a network node via the relay UE on a UE-to-network relay path to the first UE, wherein the PDCP PDU is delivered to the network node via at least one of:
a UE-to-network relay path, or
a UE-to-network direct path.

22. (canceled)

23. The method according to claim 21, wherein the indication is a RLC status report indicating that the PDCP PDU has been successfully transmitted to the relay UE in a sidelink, or
wherein the indication indicates the relay UE has received a RLC status report for the PDCP PDU from the network node.

24. (canceled)

25. The method according to claim 21, further comprising:
1) receiving a signaling from the first UE, wherein the signaling indicates the relay UE to discard at least one second duplicated PDCP PDU and/or RLC SDU associated with the uplink radio bearer; and
discarding at least one second duplicated PDCP PDU and/or RLC SDU associated with the uplink radio bearer, wherein the at least one second duplicated PDCP PDU and/or RLC SDU comprises at least one of:
one or more PDCP PDUs and/or RLC SDUs associated with the uplink radio bearer that are received from the first UE and stored in at least one sidelink RLC entity, or
one or more PDCP PDUs and/or RLC SDUs associated with the uplink radio bearer that are stored in at least one Uu RLC entity, or
receiving a signaling from the first UE, wherein the signaling indicates the relay UE to discard at least one fourth duplicated PDCP PDU and/or RLC SDU associated with the uplink radio bearer and the at least one RLC entity; and
discarding at least one fourth duplicated PDCP PDU and/or RLC SDU associated with the uplink radio bearer and the at least one RLC entity, wherein the at least one fourth duplicated PDCP PDU and/or RLC SDU comprises:
one or more PDCP PDUs and/or RLC SDUs associated with the uplink radio bearer that are received from the at least one RLC entity of the first UE and stored in one or more sidelink RLC entities, and/or
one or more PDCP PDUs and/or RLC SDUs associated with the uplink radio bearer that are received from the at least one RLC entity of the first UE and stored in at least one Uu RLC entity.

26. (canceled)

27. (canceled)

28. (canceled)

29. The method according to claim 21, further comprising:
1) receiving a signaling comprising an identifier of the first UE from the network node, wherein the signaling indicates discarding duplicated PDCP PDUs and/or RLC SDUs associated with the uplink radio bearer; and
discarding duplicated PDCP PDUs and/or RLC SDUs associated with the uplink radio bearer, or
2) receiving a signaling comprising an identifier of the first UE from the network node, wherein the signaling indicates deactivating at least one RLC entity of the uplink radio bearer in the UE-to-network relay path; and
deactivating at least one RLC entity of the uplink radio bearer in the UE-to-network relay path.

30. (canceled)

31. The method according to claim 21, further comprising:
maintaining a mapping table between Uu PDCP PDUs and sidelink RLC PDU in the UE-to-network relay path, wherein the mapping table comprises at least one of:
a mapping of a PC5 RLC PDU to one or multiple Uu PDCP PDUs, or
a mapping of one or multiple PC5 RLC PDUs to a Uu PDCP PDU.

32. (canceled)

33. (canceled)

34. (canceled)

35. (canceled)

36. A method performed by a network node, comprising:
for a downlink radio bearer that has been activated with PDCP duplication, determining that a PDCP PDU has been successfully delivered to a first UE via a relay UE on a UE-to-network relay path; and
discarding at least one duplicated PDCP PDU on at least one other UE-to-network path, wherein the at least one other UE-to-network path comprises at least one of:
a UE-to-network relay path, or
a UE-to-network direct path.

37. (canceled)

38. The method according to claim 36, wherein determining that the PDCP PDU has been successfully delivered to the first UE via the relay UE on the UE-to-network relay path comprises:
1) receiving a RLC status report from the relay UE, wherein the RLC status report indicates that the PDCP PDU has been successfully transmitted to the relay UE in a Uu link; and
determining that the PDCP PDU has been successfully delivered to the first UE via the relay UE on the UE-to-network relay path based on the RLC status report, or
2) receiving a PDCP status report from the first UE, wherein the PDCP status report indicates that the PDCP PDU has been successfully received by the first UE via the UE-to-network relay path; and
determining that the PDCP PDU has been successfully delivered to the first UE on the UE-to-network relay path based on the PDCP status report, or
3) receiving a first signaling from the relay UE, wherein the first signaling indicates that the relay UE has received a RLC status report for the PDCP PDU from the first UE, wherein the RLC status report indicates that the PDCP PDU has been successfully transmitted to the first UE in a sidelink; and
determining that the PDCP PDU has been successfully delivered to the first UE via the relay UE on the UE-to-network relay path based on the first signaling, or
4) receiving a second signaling from the first UE via a UE-to-network direct path, wherein the second signaling indicates that the PDCP PDU has been successfully received by the first UE via the UE-to-network relay path; and
determining that the PDCP PDU has been successfully delivered to the first UE via the relay UE on the UE-to-network relay path based on the second signaling.

39. (canceled)

40. The method according to claim 38, wherein the PDCP status report is received by the network node when at least one of:
an upper layer requests a PDCP entity re-establishment,
an upper layer requests a PDCP data recovery,
an upper layer requests a downlink data switching,
an upper layer reconfigures a PDCP entity to release dual active protocol stack (DAPS) and daps-SourceRelease is configured in upper layer,
an upper layer determines that a PDCP status report needs to be triggered,
a periodic timer is expired, or
PDCP duplication has been activated and at least one path for PDCP duplication is the UE-to-network relay path.

41. (canceled)

42. (canceled)

43. (canceled)

44. (canceled)

45. The method according to claim 36, further comprising:
determining to deactivate the PDCP duplication of the downlink radio bearer;
performing at least one of:
deactivating the PDCP duplication of the downlink radio bearer;
sending a third signaling to the first UE, wherein the third signaling indicates deactivating PDCP duplication of the downlink radio bearer;
sending a fourth signaling to the first UE, wherein the fourth signaling indicates deactivating at least one sidelink RLC entity for the downlink radio bearer on the UE-to-network relay path;
sending a fifth signaling to the relay UE, wherein the fifth signaling indicates deactivating at least one Uu and PC5 RLC entity for the downlink radio bearer on the UE-to-network relay path;
discarding at least one duplicated PDCP PDU and/or RLC SDU associated with the downlink radio bearer; or
sending a sixth signaling to the relay UE, wherein the sixth signaling indicates discarding at least one second duplicated PDCP PDU and/or RLC SDU associated with the downlink radio bearer.

46. The method according to claim 45, wherein the at least one second duplicated PDCP PDU and/or RLC SDU comprises:
one or more PDCP PDUs and/or RLC SDUs associated with the uplink radio bearer that are received from the network node and stored in at least one Uu RLC entity of the relay UE, and/or
one or more PDCP PDUs and/or RLC SDUs associated with the uplink radio bearer that are stored in at least one sidelink RLC entity of the relay UE.

47. The method according to claim 36, further comprising:
maintaining a mapping table between Uu PDCP PDUs and Uu RLC PDU in the UE-to-network relay path, wherein the mapping table comprises:
a mapping of a Uu PDCP PDU to one or multiple Uu RLC PDUs, and/or
a mapping of one or multiple Uu PDCP PDUs to a Uu RLC PDU.

48. (canceled)

49. (canceled)

50. The method according to claim 47, wherein an entry corresponding to a Uu PDCP PDU is added into the mapping table when the Uu PDCP PDU is delivered to a Uu RLC layer and the entry corresponding to the Uu PDCP PDU is deleted when the Uu RLC layer indicates to a Uu PDCP layer that the Uu PDCP PDU has been successfully transmitted to a receiver or the Uu PDCP PDU has become invalid when a timer or a counter is expired.

51.-60. (canceled)
